(19) United States
(12) Patent Application Publication
(10) Pub. No.: US 2015/0269639 A1
(43) Pub. Date: Sep. 24, 2015

(54) Referent-Centric Social Networking

(71) Applicant: Avi Mistriel, Kochav Yaakov (IL)

(72) Inventor: Avi Mistriel, Kochav Yaakov (IL)

(21) Appl. No.: 14/635,318

(22) Filed: Mar. 2, 2015

(30) Foreign Application Priority Data
Mar. 3, 2014 (IL) 231281

(51) Int. Cl. G06Q 30/02; G06Q 50/00

(52) U.S. Cl. CPC G06Q 30/0282; G06Q 50/01

(57) ABSTRACT

Providing access to a collection of Authenticated Services Quality (ASQ) user reviews, feedbacks, and comments, Referent-Centric Social Networking platform includes generic format templates and records, which may be substantially disbursed in an amorphous data network, and methods actualizing trans-author communications about aspects in and of these records. A record typically includes an authorized owner identification of the record, a comment by the owner that the owner deems relevant to referent by a different owner, linkage pointing to a localization of the referent, and a degree of access to the comment of the record, and respective social networking facilities. Applying arbitration policies and protocols, ASQ also relates to real world data problems where validity of data aggregated from an ensemble of respectively commenting authors is critical to robustness of information, to diversifying communication networking between authors of mutual interest, and to enhancing Role Based Authorization analysis.

### CROSS-REFERENCE TO RELATED APPLICATIONS

This application claims priority from REFERENT-CENTRIC SOCIAL NETWORKING, Request Number 231281, Mar. 3, 2014, Israeli Patent Office (ILPO).

### SUMMARY

Very simply, embodiments of the instant invention relate to electronic communications for social networks, which preferably respect privacy while discouraging anonymity, and to improved levels of information-content trustworthiness therein. Generally, the instant invention relates to convergence from informatics quanta (electronic data and records) onto manifold modeling of interpersonal communications (databases and telecommunications networks) concerning goods, services, or ideas of mutual interest to the respective communicators. More specifically, the instant invention relates to a platform evolving relationships between communicators; to clustering, stratifying, and organizing information there-between; and to interactions characterized as indicia statistics, metrics, calculus, topology, and information phase-transition dynamics thereof. Alternately stated, with the objective of facilitating some Authenticated Services Quality (ASQ) knowledge, the instant invention basically relates to human-interest validation-centric transformation-priority protocols for beneficially adapting ordinary electronic communications onto ordinary electronic data networks and to systems and methods for improving user-recognizable quality therein.

### BACKGROUND ART

Before getting into any great complexity of detail, here is a simple scenario that you can keep in mind while thinking about the instant invention.

Say that you want to buy a car. You find a Unique make & model (an “Umm”), and after researching all of the technical details, you think that this may be the Umm for you. But before you go buy your Umm, you decide to try to find out if Umm owners like their Umm. So, you go onto the internet and find whole sites devoted to Umm owner comments, Umm owner discussions, Umm owner demographics, Umm owner whatever-you-can-imagine, and the like. Now, after spending endless hours on these sites, two things begin to bother you.

First, each site seems to belong to some central site owner, and each respective site owner seems to have his own special interest, like making money from site advertising, or becoming famous for site controversy, or selling Umm accessories, etc.

Second, it is difficult to convince yourself that lots of this Umm owner commentary and Umm owner discussion is real. You begin to suspect that sometime a disgruntled Umm owner is making a disproportionately huge amount of bad noise. You suspect that sometimes the Umm manufacturer is paying some junk-writers to fill these sites with Umm praises. You suspect that sometimes Umm competitors are paying other junk-writers to fill these sites with Umm bunk. You even suspect that some Umm enthusiasts are venting their Umm missionary zeal on these sites. By the end of your endless hours surfing the net for the Umm truth, even though you realize that in between all of that false Umm is lots of real Umm owner revelation, you decide to just wander around on the real street or to use your real telephone to try to find at least one real Umm owner, and to ask him for a simple “Yea or Nay” about his Umm experience, statistically insignificant as it may be.

This scenario is an example of a kind of problem that you and everyone that you know has encountered. Umm can be most anything. Umm can be goods and Umm can be services. Umm can be quality of medical care. Umm can be educational instruction success. Umm can be hotel hygiene. So, please keep your real-world Umm frustrations in mind when you are trying to appreciate embodiments of the instant invention, because the instant invention is a family of constructions for at least partially circumventing the ongoing Umm dilemma, for breaking some of the endless Umm paradox, for helping with other everyday experiences of trying to get truth out of Umm data, and the instant invention also relates to improvements for some informatics issues that are much larger than any Umm.

There are many product configurations that collect, aggregate, and even publish feedback from users of commercial goods and services, a potentially relevant sampling of which includes: U.S. Pat. No. 5,712,960 System and Methods for Intelligent Database Management using Abductive Reasoning; U.S. Pat. No. 8,010,560 Abducing Assertion to Support Access Query; U.S. Pat. No. 8,065,240 Computational User-Health Testing Responsive to a User Interaction with Advertiser-Configured Content; U.S. Pat. No. 8,170,906 Method and Apparatus for Information Surveying; US 20100205649 Credential Gathering with Deferred Instantiation; and US20130096986 System and Method for Selective Redaction with Real Time Feedback. While these prior art materials help orient the reader to understand some of the many vantages of how feedback may benefit merchants, service providers, and data facilitators, in order to clearly appreciate the present invention, the reader will need to contemplate what feedback might be most helpful to a potential customer.

Another potentially relevant sampling includes: U.S. Pat. No. 6,282,548 Automatically Generate and Displaying Metadata as Supplemental Information Concurrently with the Web Page, There Being No Link Between Web Page and Metadata; WO-2002091193 Web Page Annotation Systems; WO-2007070791 Decentralized Web Annotation; US20120221479 Web Site, System and Method for Publishing Authenticated Reviews; U.S. Pat. No. 8,438,617 User Authentication Based on Voucher Codes; U.S. Pat. No. 8,219,499 Community Hub Review; U.S. Pat. No. 7,860,803 Method and System for Obtaining Feedback for a Product; and WO-2010028071 Systems and Methods for a Comprehensive Integrated and Universal Content Selling and Buying Platform.

Abduction has been described as a type of inference that assigns special status to explanatory considerations. These (typical of the prior art) abduction feedback systems (substantially compliant with forms of logical inference following the concepts of C. S. Peirce) seem to be cognizant that there are complex reliability aspects to user and customer reviews and comments, yet they substantially prove that there is a large plurality of overlapping functional configurations within a much larger view of conceptualizing how to address vendor and customer needs for valid assessments without excluding the layman from facile access. Accordingly, there are three interrelated longstanding needs: to provide a facile format for accumulating authenticated customer feedback, to provide facile access to general access to relevant feedback, and to provide facile authenticated social networking communications related to that feedback, and the prior art neither reasonably suggests a need for such a combination nor teaches any appropriate configuration that could enable it.

Simply stated, including all of the market sensitivity functionality now provided by prior art systems, most potential customers will rely strongly on single instantiations of recommendations or cautions from a friend or even from a statistically-insignificant serendipitous stranger, rather than be guided by the wisdom of a relevant large-data-sample summary, because most customers are skeptical about the validity of such summaries. The ordinary customer has some good reasons for his skepticism. Many items in a subjective data sample may come from vendors praising themselves, from competitor trying to poison the data, or from a single feedback-frenzy customer who passionately believes that his individual experience is absolutely indicative of the experience of all customers. Accordingly, it is not known to the customer if a large-data-sample summary is highly relevant (true) or perversely biased (false), and, therefore, the customer cannot be a rational decision maker. It is an objective of the instant invention to help the customer to become a more rational decision maker. It is also an objective of the instant invention to make large-data-sample more robust (having a higher truth bias) and, in many instances, to help decentralize aspects of customer feedback into something more typical of customer forums.

By virtue of the nature of the instant invention, for some readers, a better understanding may arise (at any time during the reading of this document) by turning to the “Instant Application Examples” in the “Description of Embodiments” section (below) and then returning here. This multiple reading of the “Instant Application Examples” (here and then in their normal context there) is a more economic presentation of the invention, since it helps (some readers) by suggesting narrow practical examples and then allowing the reader to further appreciate technology-scale embodiments of the instant invention, which span up to exceedingly larger resolution metrics of applicability.

Now (or continuing after the “Instant Application Examples”), first, a recitation of current communications systems, information products, and the respective failure of the market to appropriately integrate them together; then, an abstract academic orientation to the relevant meta-semiotic issues of ethereal communications trans-morphology facilitation; and thereafter, a few convenient definitions.

### Communications Systems and Information Products

Today, there are many communications systems; however, virtually all are topologically similar (of like connectivity and/or having like relationships) to legacy telephone or legacy radio systems. Legacy telephone systems and PBX are primarily communications connecting two endpoints, typically a voice exchange between a caller and a receiver, albeit the occasional conference call may have multiple parties “on the same line”. Legacy radio systems are typically broadcasting from one to many, albeit sometimes breaking out of the one-to-many topology with sequential listener call-in or listener voting. Even though these legacy communications systems use numerical addressing (telephone numbers or broadcast frequencies), the callers, receivers, broadcasters, and listeners generally identify each other by name. Classical telephone directories are organized by name within region, and commercial telephone directories are organized by goods or services within region. Radio program guides are organized by broadcast frequency, call letters, schedule of broadcasting slots, and presenter and headline (summary) of content for the respective slots.

More Internet enabled communications networks (such as email, Facebook™ or Skype™) generally serve to interconnect parties by name (or pseudonym), while search engines for web-pages are really just looking up item-combinations (key words) in a continuously updated commercial style directory (which is transparent to the user). Subjective filtering orientation devices try to help sort the user or vendor preferred items to a higher status. Chat rooms and visitor comments are likewise the equivalent to listener call-in or listener voting. Simply stated, while actual systems may have peculiarly complex metrics of connectivity relationships, users of such systems are presented with simplistic individual-to-individual or individual-to-group views of the system, and with simplistic bullet-point (outline) views of content therein.

Nevertheless, there are many information products that are configured to help administrators relate to content complexity manifolds, such ones based on any of the at least five Boyce-Codd Normal Forms, on other quasi-ontological Rules of Data Normalization, and the like. Unfortunately, even content complexity trained intelligence officers have trouble condensing a large-data-sample that includes many degrees of validity questionable data. Accordingly, it is not surprising that large user-based communications networking has not evolved into any higher intelligence standard for appreciating customer feedback, because the complexity of mixed validity data does not seem to reduce to ordinary common sense summary. Thus, it is an objective of the instant invention to help maintain a higher standard of validity for respective appropriate large-data-samples. Alternately stated, by the failure of a facile convergence of functionality from the above mentioned categories of products, there remains an unanswered need to provide communications for a content-centric community.

### Meta-Semiotic Trans-Morphologies

For those looking for an alternative context, a very vague ontological category for the problem that the instant invention addresses may “almost” be found in Mundbrod's 2012 Master Thesis submitted to Ulm University, entitled “Business Process Support for Collaborative Knowledge Workers” (p. 106—FIG. 5—in the “emergent” direction) [see http://dbis.eprints.uni-ulm.de/791/1/MA_Mundbrod,%20Nicolas_BP%20Support%20for%20Collab.%20Knowledge%20Workers.pdf]; however, he neither considers nor develops the issue from the perspective of the frustrated consumer (who seems to be, for Mundbrod, a struggling knowledge-amateur), etc.

From quite a different vantage, information, expressed as an economy, presents some peculiar conservation-law violating asymmetries. Considering the ordinary economic consumer-producer relationship results in the strange phenomenon that looking for information, looking at information, ignoring information, and certainly copying information creates new information if those information interaction events are recorded. Accordingly, when communications is included in the world of information (meaning that there exists information access), then every information consumer becomes a simultaneous producer of further information. This is a sort of first law of information, that information explodes into data-manifolds with communications.

Now, communications are normally considered as relationships between communicators, which then suggests that social networks of communications are relationship centric. While it is true that relationships become significant to communications direction and communications load characteristics, the information being communicated is actually a focus of the network according to an information economy centric transformation view. A sort of second law of information is that communications, surrounding any content quanta, create a cloud of meta-information (another data-manifold), which describes the communications network, the social status modeling of the communicators, and meta-metrics of the exploding information within and regarding the respective content quanta.

Accordingly, wherein social networks have proven to be valuable real time approximations of needs for interactions between substantially known communicators, there is also a need in the art to address the evolving motivations of the communicators, which is centric to respective content quanta—such as consumer feedback regarding goods or services.

Alternately stated, information is a peculiar class of goods and communications is a peculiar topology of services encapsulating, processing, transporting, and transforming those goods. Now, the goods have many properties which characterize them as-if animate in that they live, reproduce, die, hibernate, hybridize, and evolve to diversify—as is the tendency of complex ecological systems. In this view, communications is to information like natural and man-made activities are to terrestrial ecology, having a range of ecologically productive and/or counter-productive effects.

At present, simplistically summarized, there is a longstanding need for electronic communications to catalyze scale independence potentials of content-centric communications and/or to allow potential consumers the benefit of communicating with real consumers and/or with a higher standard of validated consumer feedback. Thus, in the current world, any improved large-data-sample of comments and of feedback becomes a substantial abduction inference manifold, which is compliant with virtually all the aforesaid.

### Introductory Definitions

Referent: In ordinary use herein, a referent is “the thing in the world that a symbol or word or phrase denotes or stands for”; “the object or idea to which a word or phrase or term or symbol refers”; “the concrete object or concept that is designated by a word or expression.”; “information, person, thing, event, idea, service, object, action, state, relationship, or attribute”; and in the context of data processing, information science, electronic communications, and software enabled systems, a referent is “content” such as data (per se), text (per se), images (per se), recordings (per se), and metrics thereof; likewise, transactions, publications, broadcasts, announcements, records thereof, or the like.

Abduction: In ordinary use “Abduction is a form of logical inference that goes from observation to a hypothesis that accounts for the reliable data (observation) and seeks to explain relevant evidence.”; “Abductive reasoning typically begins with an incomplete set of observations and proceeds to the likeliest possible explanation for the set. Abductive reasoning yields the kind of daily decision-making that does its best with the information at hand, which often is incomplete.”; “Abductive reasoning is, reasoning in which explanatory hypotheses are formed and evaluated.”; “Abduction merely suggests that something ‘may be’; so (functionally) a logical Abduction of an Instantiation [‘A(I)’] is a commentary, wherein an author [‘J’] posits at least one comment [‘K’] as a relevant cause, co-factor, effect, or corollary to [‘I’]”, or the like. Accordingly, as an exemplary first approximation for the text hereinafter, a “comment” is a logical abduction of some referent, and the comment generally posits, demonstrates, illustrates, or proves, some relevant cause, co-factor, effect, or corollary related to at least one aspect of the referent or related to at least one portion of the referent. Kindly note that a much more detailed discussion of “abduction” is provided shortly after the explication of FIG. 4 in the “Disclosure of Invention” section (below).

Manifold: Simply stated, a manifold is a data structure, such as is found in databases and in telecommunications. In ordinary use herein, a manifold is “A topological space where each point in the topology is capable of having a model which includes a neighborhood around that point, such as is found in logically and/or physically related data structures, and in interconnected computation and/or communications architectures (such as processors, routers, servers, gateways, and the like).”, “The concept of a manifold . . . allows more complicated structures to be described and understood in terms of the relatively well-understood properties.”; “Every manifold has an underlying topological manifold, obtained simply by forgetting the additional structure.”; “A manifold often relies on the concept of charts and atlases (of charts) which, in turn, allow visualization or representation of any point in the manifold and any neighborhood (scale) thereabout; thereby avoiding scaling problems for otherwise poly-dimensional and sparely-populated data structure instantiations—such as are typically occurring in network traffic data.”; also “An intermediary data structure, preserving content and relationships there-between; used in transformations for partial visualizations and for showing various resolutions of the data content and/or data relationships.”; or the like.

### BRIEF DESCRIPTION OF THE DRAWINGS

In order to understand the invention and to see how it may be carried out in practice, embodiments including the preferred embodiment will now be described, by way of non-limiting example only, with reference to the accompanying drawings. Furthermore, a more complete understanding of the present invention and the advantages thereof may be acquired by referring to the following description in consideration of the accompanying drawings wherein:

FIG. 1 is a schematic view of a specific ASQ Referent-Centric Social (RCS) Network variant;

FIG. 2 is a schematic view of a general RCS Network variant;

FIG. 3 is a schematic view of an RCS Networking Method;

FIG. 4 is a schematic view of an RCS Networking appurtenant Article;

FIGS. 5-9 are schematic views of generation events of an ASQ RCS Network record; and

FIGS. 10 and 11 are schematic views of other RCS Network record creation processes.

### INDUSTRIAL APPLICABILITY

A presentation of selected ergonomic, economic, and technical issues, which highlight Advantages, Objects, and Benefits of the instant Invention.

Ergonomic Issues: Today, because social networks generally respect privacy but rarely discourage public anonymity, there is a failure to maintain a sufficient standard of information responsibility; and, therewith, information quality is compromised, diluted, and degraded; and loyalty, trust, and other fundamental aspects of traditional human networking are destabilized. Typically, an authoritarian freedom-to-censor policy is imposed, to limit the problem; such as a site owner or moderator deleting comments, or banning individual posters. Spam email is another version of this information responsibility disparity. Actually, at almost any level of scale and of resolution, electronic communication channels present the human receiver with bothersome levels of irresponsible information to responsible information, which is the human intelligence equivalent to a high noise-to-signal ratio. For many social network applications, loss of anonymity would turn many participants into observers, bystanders, and “refugees”, while anonymity with a “certification of status” will often at least overcome the spammers ability to contribute information-litter, yet allow sincere persons to overcome their respective resistance to expressing critical views. Simply stated, in an information “proper” world, only licensed professionals are capable of categorizing the quality of their respective professional peers, but in the “real” world, actual customers and actual service recipients (and actual professional peers, rather than peer licensing boards) have some important information to contribute—as validation or invalidation to those “ethical and courteous” professional peer ratings. This is the potential of a meta-level of information for social networks, and the instant referent-centric social networking method provides a transformational view to activate social stability in the current fickle amorphous electronic-communications environment.

Economic Issues: The entire idea of advertising, which so dominates today's communications economy, is actually obsolete, but no one has seemed to notice that. The historic boom in advertising came with the mass population shift from being a respectively familiar agrarian population to being a substantially anonymous mega-urban population. In a socially traditional society, a person seeks out providers of goods and services based on personal recommendation from trusted personal associates, not from strangers, actors, nor paid strangers, and certainly not from the providers of the good and services. The personal loyalty of friends making such recommendations leads to robust relationships characterized by both customer loyalty and merchant loyalty. Simply stated, in today's post-urban society of global customer-merchant relationships, embodiments of the instant referent-centric social network (using certifications of authenticity) fills some of the longstanding trustworthiness needs of the mega-urban transaction relationships and of the even more anonymous global-distance transactions relationships, changing the face of postindustrial economics from a price comparing herd-mentality market to a quality comparing loyalty market. This is the underlying issue motivating all of the basic embodiments of the present invention, using a social network to build a robust renewable marketplace economy, rather than supporting a deceptive ontology of false labels (e.g a “relationship manager” who is actually often just a false face in the hierarchy of corporate interest's representation, a “Life Coach” who is actually often just a far-from-geriatric-age person who has barely experienced anything more than a crash course or a few years study of popular psychology, etc.)

### Technical Issues

Author, title, and subject have existed since the dawn of written materials, yet as keys to external index classification, their historical introduction (the Dewey Decimal Classification) facilitated an information access explosion of scale. In a similar way, authored content, author of contact location, and content storage location have long existed, yet, for electronic records in data networks, search engines typically provide a web searching experience which jumps from one authored content with associated content storage location to another authored content with associated content storage location. This web surfing activity “experience” almost follows the patch-chord operator switchboard model. Simply, for the user who is searching for more than just information, for the user who is searching for human interaction with authors, and, by extension, who are searching for human interactions with authors of comments to any part of that information (amorphous abductive data network)—there is a longstanding need for a navigable layer (or an equivalent functional manifold) above the “knowledge graph” (a term of the art relating to structural parsing and also to a recent Google pseudo-abductive data product which includes a semantic network but neither provided independent nor decentralized data-validation transparency.) allowing direct inter-author communications, and various filters and aggregations of authors abductive comments.

### Disclosure of the Invention

The aforesaid longstanding needs are significantly addressed by embodiments of the present invention, which specifically relates to communications for a referent-centric community. The instant protocols are especially useful in society-computer interactions wherein there exist actual needs or economic benefits from allowing higher resolution query and manipulation of abductive data while simultaneously not forcing individual privacy to be breached.

The instant invention relates to embodiments of a Referent-Centric Social Network, for improved Authenticated Services Quality validation, the network comprising an ensemble of electronic communications records, wherein said records respectively include: (A) a validated identification of a commenter; (B) a comment owned by the commenter which relates to referent of a different owner, wherein said comment includes at least one (preferably third party authenticated) profile relationship (such as by tagging with a tag, or a Vtag, or the like) between the commenter and the referent owner; (C) linkage pointing to a localization of the referent; (D) electronic communications access to the comment; and (E) respective social networking facilities selected from the list: (I) an interactive electronic communications access between the commenter and the referent owner, (II) a commenter centric broadcast of the comment to a substantially appropriate group, (III) a referent centric aggregation of related comments from a substantially appropriate group, (IV) a network centric summary of any of the aforesaid for a substantially appropriate group activities, or it's participants comments, and (V) a dynamic view of any of the aforesaid.

In answer to the fundamental problem of authenticity of commentary, embodiments RCS Networks provide third party verification of relationships tags between the comment owner and the owner of the referent that the cement is relate to. Thus, for example, a comment about the quality of food at a restaurant, may at least verify that the commenter had a credit card payment to that restaurant; a comment about quality of medical care at a hospital may at least verify that the commenter had authorized an insurance payment on his behalf to that hospital (or that there is a medical record of such care in the hospital's database); a comment about municipal services may at least verify that the commenter is a resident of that municipal jurisdiction; etc. The nature of the third party verification may depend on the classification of validated descriptive tags (Vtags) assigned to the comment and to the referent of that comment, and may also depend on the policy of a respective referent owner, as described herein. Examples of classes of relationships which may be verified may be such things as employee-employer, customer-vendor, patient-doctor, student-teacher, audience-performer, and the like. Other types of comments may be more ambiguous to verify, such as a reader's comment about a news report; however, demographics about the reader may be verified, so that an RCS network may at least provide that comments are derived from a known age group, gender, income bracket, education level, professional certification, or the like.

The instant invention also relates to embodiments of A Referent-Centric Social Network, providing Authenticated Services Quality content, the network comprising an ensemble of electronic communications records, wherein said records respectively include: (A) a validated identification of a commenter; (B) a comment owned by the commenter which relates to referent of different owner, wherein said comment includes at least one authenticated profile relationship between the commenter and the referent owner; (C) linkage pointing to a localization of the referent; and (D) respective social networking facilities—such as a degree of electronic communications access to the comment, wherein said access includes an interactive electronic communications access between the commenter and the referent owner.

More specifically, while “a validated identification of a commenter” may reveal the identity of the commenter or may reveal properties of the commenter or may reveal some self disclosure provided by the commenter; identification validation means that a RCS network has accepted the respective properties and/or identity as valid, certified, authenticated, probable, and/or true. Therefore, as an initial exemplary approximation, embodiments of the instant RCS Network empower opinion data sets of improved reliability, a modicum of progress referred to herein as “Authenticated Services Quality” (ASQ) content. These RCS networks are partially convolved from an ensemble of electronic communications records of substantially abductive information. So, very simplistically stated, these records respectively include (C) a reference to some modicum of referent which is the target of a commentary; (B) an abductive opinion about that referent—having a relevant ASQ tag; (A) identification for the author of the opinion; and (D) access to the comment including possible interactive communications between an owner of the referent and the author of the opinion. Firstly, atypical to many data networks, an RCS network can be a large plurality of disjoint record clusters, and these clusters may be amorphously distributed and/or centralized substantially because that is the status of the respective referent owners, opinion authors, and accessing parties. Secondly, having a valid identification of the commenter allows third party authentication of profile relationship(s) between the commenter and the referent owner, which substantially support or restrict the commenter's standing to make a comment about the referent.

Tag, VTag, RelTag: In ordinary use, a tag is “a label allocated to identify data in memory”; “a piece of code that defines different elements”; “a markup construct”; and in the current context, a “Tag” is a descriptor (of any of numerous kinds). The tag may be a descriptor of a referent, of a profile element, or of a relationship. The tag may include an authentication status or state for its description, since a descriptive tag is also a referent. So, simply stated, there are two types of tags, descriptive tags and validated descriptive tags. The validated descriptive tag certifies that this tag has been authenticated as an appropriate truthful description according to an external party, thereby changing the tag from a subjective descriptive tag to a substantially objective descriptive tag. However, in the context of the instant invention, a tag is an expression that is provided to teach and to illustrate some of many possible implementations, wherein the tag may also be used to denote a physical or logical aspect of an embodiment.

Generally, a tag (like an XML tag, a meta-tag, a data-tag, or a flag in a database) may describe a referent, and a variation of that tag may validate or authenticate a truth or reliability of the referent or a truth or reliability of the descriptive tag. For example, a referent may be “The Happy Eatery, address, phone, website” and a descriptive tag of that referent may be “restaurant” and a validation of that descriptive tag (hereinafter, a “Vtag”) may be “Licensed food establishment—as per government registry XXX”. Likewise, a validated relationship would indicate, for example, that there is a transaction showing that a customer purchased food at that restaurant (E.g. Validated Customer Vtag). For simplicity, a validated tag (be it descriptor, relationship, or otherwise) herein is called a “Vtag”. In a more technical view, Vtags are translated to be some authentication process that matches any unique IDs acquired by the record for any interrelated process, or any unique id related to related users with some 3^{rd} party non-biased (trusted) records.

Tags are also useful as expressions to teach or to illustrate descriptive modifiers, which express aspects of a communications topology that are defined for a record having that tag—such as criteria of (A) visibility to see content or comments in a record, (B) of accessibility to participate to comment on or about that record), and (C) of respective communities (on the fly defined Vtag collaboration “group”) to whom the record may be visible, accessible, broadcast (transmitted to), etc. Another new aspect of this topology manifold embodiment is the ability to establish social community (group) that it's membership criteria is Vtag dependent E.g only to certified medical doctors, only to local law enforcement persons, etc., logically relative (such as only to a commenter that are older than the author of a comment, only to persons living within the post code of a referent, etc.), logically relational (such as only to a commenter that has a recent commercial transaction with the referent, only to a graduate of a specified educational institution, etc.), by-degree (such as until there are 25 comments for one level and until there are 100 comments for the next level), temporal (such as up to a specified date, or within 30 days of the comment's date, etc.), is these cases members should accept Vtag validation in order to be part of that community and to manipulate records within. Of course, as a RCS is a social network it also allows “simple” community topology so that a membership may be absolute (such as only to my networking friends or any other pre-selected people by group owner) or a totally open group available to everyone to join etc.

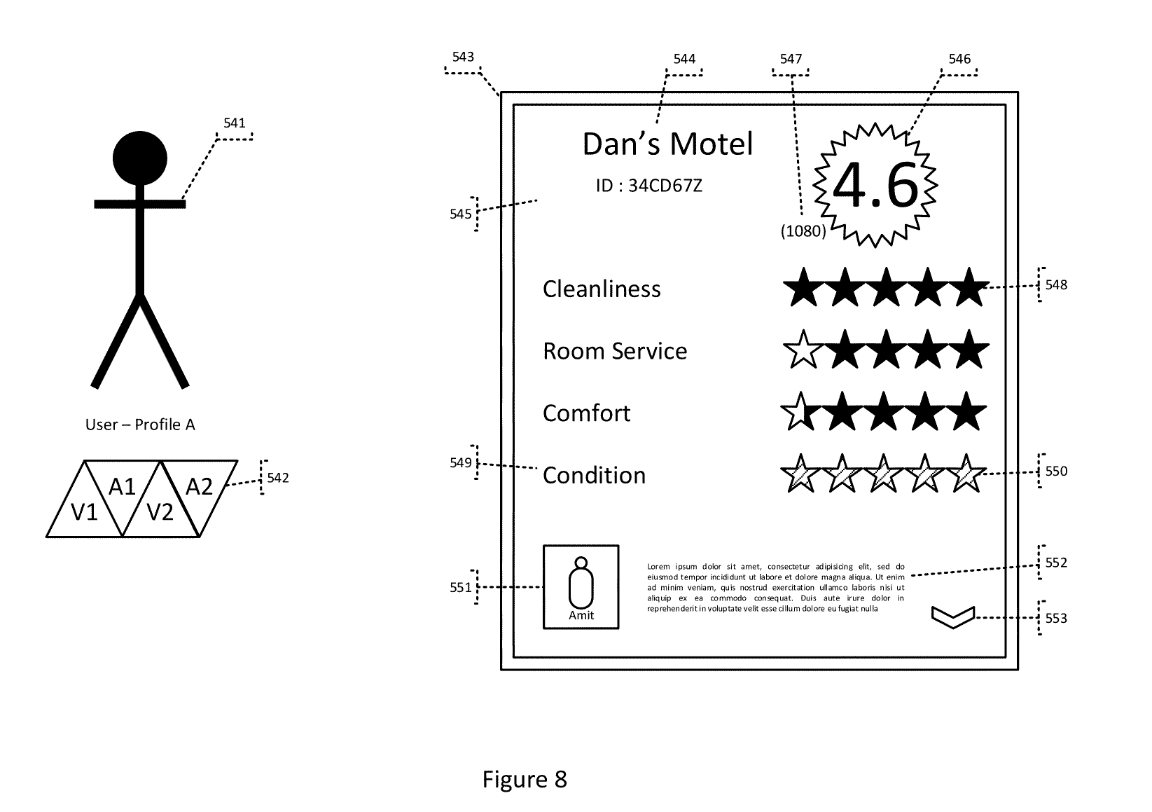

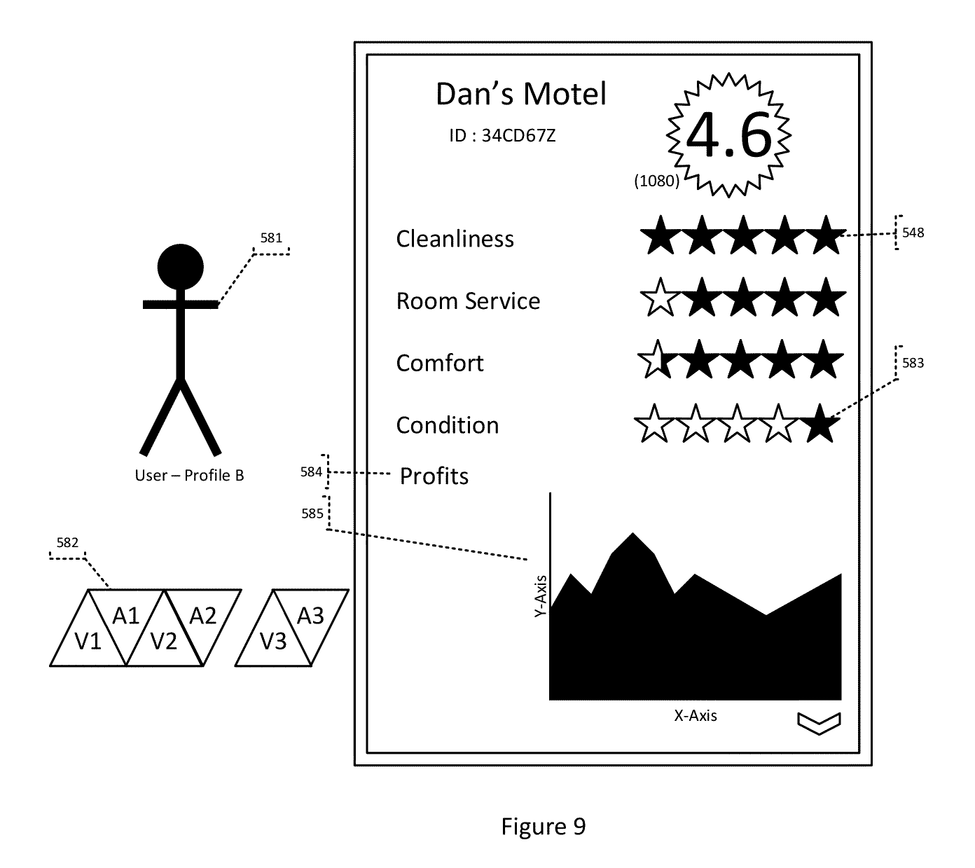

In the context of various embodiments of the instant invention, there are at least three usages for tags. Firstly, tags are used to designate identification of a commenter, for describing a profile element for the commenter, and for denoting the type and degree of validation for the identification of the commenter. Secondly, tags are used in a similar manner with respect to the referent owner. Thirdly, tags are used by the authenticated services quality ASQ provider as the basic units of an arbitration protocol which may be used to resolve conflicts of visibility, accessibility, or comment-ability between the commenter and the referent owner, likewise to resolve conflicts of criteria (such as those mentioned in the previous paragraph) between any of the commenter or the referent owner and their respective RCS Networking associates and the ASQ policies of the RCS Network administrators (such as may be further appreciated when considering 542 in FIGS. 8 and 582 in FIG. 9).

Another practical usage of tags as a descriptor of relationship is the introduction of a Relationship Tags (AKA “RelTags”) by using an exemplary ampersand tag “&” notation in order to denote some profile detail that enlightens the relationship between the commenter and the aforesaid referent element. Examples of such RelTags can be &Teacher, &Customer of some vendor, &Vendor, &Working at XYZ company at ABC department or the like.

RelTags can be 3^{rd} party validated, as they are a subset of Vtags, making the profile detail more trustable in terms of abductive reasoning. In case the RelTag also has validation, the relation tag denotes some validation notation (E.g. “!” or “^{✓}”). For example: “&Customer!”, “&Customer^{✓}” or any other parsing recognition unambiguously-identifiable glyph-icon, lexicographic, icon notation, or the like.

The aforesaid 3^{rd} party validation tagging process (in context of RelTags) includes at least one of the following validations: Relative-Validation: A user/group that is authorized to authenticate RelTags; Absolute-Validation: cross checking information with some institute servers in order to acquire confirmation about the user details; Subjective-Validation: Where individuals or groups introduce some acknowledgment or connection to a specific RelTag.

The aforesaid Validation, in lack of 3^{rd} party validation, can be substituted by a mean(s) of personal confirmation: where the user itself introduces some confirmation to his claimed RelTag, such as some photo, recording, textual content or any evidence supporting his claim. This kind of validation is “weaker” sometimes in respect to 3^{rd} party validation, however it assist people to become more rational decision makers.

In a more general sense, tagging is a path or path-segment through an information processing protocol wherein an item of information (of a substantially designated degree of scope thereof or granularity therein) is identified, such as by using a tag (preferably easily identifiable to the user—just as the hashtag is easily identifiable to the twitter user); albeit, in the current context, that tag may be validated, modified, adjusted, concatenated with further tagging, or the like.

Profile: A collection of data elements which may be authenticated, and which facilitate validation of relationships between transacting parties (such as buyer and seller, commenter and referent owner, mutually relating Vtags, etc.). Generically, a profile is a collection of attributes of an individual or of a group or of any user. For most instant implementations herein, a profile is a collection of validated identification elements for a single party (such as the validated identification elements of a user—even though the respective user may have elements which are not validated), which may then be used for third party authentication of a profile relationship between the commenter and the referent owner. A profile may be used to characterize a referent, a relationship between referents, a relationship between a commenter and a referent owner, etc. A profile typically includes any of the following elements: a descriptive tag or tags, identity information, self-description (identification) for a comment owner or for a referent owner, and respective transaction history events associated therewith. A validated profile is the validated elements of the profile for elements that are capable of being validated by a third party (E.g. personal ID number, credit card number, driving license ID, medical number id or any personal 3^{rd} party acquired issue), and/or another class of profile elements that are provided as self-definition, preferences, and the like by the respective profile owner. Because profile detail can be validated, common profile detail can invoke a RelTag to describe a relationship, for example, a common employer, or a common city of residence, etc.

A profile relationship is a profile element where two or more owners were party to a mutual transaction, even though their status within that transaction may be the same (like fans of the same sports team) or different (like a buyer and a seller for a commercial transaction there-between). An authenticated profile relationship is one where a third party can certify the validity of the mutual transactions, such as a credit card database verifying a funds transfer between the buyer and the seller, a shipping company database certifying a delivery of goods send from the seller to the buyer, and the like, or even both parties paying dues to the same club form respective membership, both parties being registered as being graduates of the same institution, and the like.

Thus, the “comment owned by the commenter” is of a logically abductive nature, and “relates to referent of different owner”. The comment then includes at least one tag (or equivalent) designating an authenticated profile relationship between the commenter and the referent owner, which then facilitates an ASQ correlation. For example, ASQ (as a generic service provider of embodiments of RCS Networking) may differentiate between a commenter who never bought item X in the store of merchant Y, the commenter who did in fact by item X in that store, and the commenter who bought an X but would like to comment on a P item on some other store Q. ASQ is all about being able to (authenticate) differentiate between levels and types of “profile relationship between the commenter and the referent owner”. Remember, RCS Networking is about improving the trustworthiness of abductive information, which (as will be described in greater detail hereinafter) may sometimes be anything from unstructured free-text to structured opinion survey type voting, grades or subjective quantification, and also any way of social networking communication between Vtag (or equivalent) qualifiers.

Now, “linkage pointing to a localization of the referent” depends on what the referent is. Thus, by one example, a linkage pointing to a blog may be an http address or a dated http address when the blog may subsequently be found in an http archive, while thus, by a very different example, a linkage pointing to a pay ground may be a street address or a latitude-longitude pair. Different from these examples, a linkage pointing to a historical event is a Geo-location or region together with a date or time period, while a linkage pointing to an actor may be to a movie and to a frame therein. Thus, according to one instant embodiment of the RCS Network, the localization of the content is selected from the list: a web-presence of the referent, a referent-centric social networking registration for the referent owner, a Geo-spatial position for the referent, a time stamp, and the like, at least one coordinate to a specific comment-relevant subset of the referent, and at least one combination of the aforesaid.

Finally, another basic property of many embodiments of an RCS Network record is that it includes “a degree of electronic communications access to the comment” so that others who would like to consider the comment as part of their appreciation of the referent (or of the commenter), may examine (read, view, listen to, etc.) the comment. Likewise, another distinguishing feature of RCS is that it provides that the “access includes an interactive electronic communications access between the commenter and the referent owner” which, in turn” enables RCS networks with a distinctly amorphous manifold topology. In addition, the degree “of electronic communications access” is determined by numerous factors; for example, by complex privacy setting set by the commenter and by the referent owner. The degree is substantially determined by the ASQ facilitator of the RCS arbitrating basic set theoretic binary relations among the records in the ensemble.

Thus, typically an enterprise, with bad customer ratings, that makes a strategic effort to improve the quality of the enterprise, may elect to restrict public access to comments made after their services quality improvements, while the public is likewise entitled to know (to see a notice) that access to comments about this enterprise, prior to a specific date, have been blocked by the enterprise (details annotated in the comment of the enterprise). Of course, customers who have registered comments prior to that blocking date may return to comment on the quality of that enterprise; however, if they have not returned to that enterprise as a verifiable customer after the blocking date, the tag (or equivalent) on their comment will entitle them to an authenticated current customer relationship status. Alternately, a disgruntled customer may become satisfied with the restitution of the enterprise, and wish to block his own comments prior to the restitution, again, with a comment explaining that his change of opinion has led him to block his prior comments from access, etc.

According to another instant embodiment of the RCS Network, the tag, designating an authenticated profile relationship between the commenter and the referent owner, is third party validated in conjunction with an access communication with at least one electronic database or data storage medium selected from the list: public records, private records, proprietary records, a professional license listing, court records, immigration records, criminal records, police records, a news archive, banking records, credit history records, credit rating records, government records, linked profile attributes, cookies, cookie-like records, elected preference records, Internet accessible information, an authenticated certificate, a photo archive, an audio archive, a multimedia archive, and any combination of the aforesaid.

According to a further instant embodiment of the RCS Network, the electronic communications access to the comment includes access to the network via at least one referent-centric aggregation portal, thereby, according to a referent relevant Role Based Authorization (RBA) parametric request, facilitating searching of referent, searching of comments to referent, organizing of related data, sorting by tag, sorting by attribute, combinations of the aforesaid, and therewith producing at least one respective summary, report, survey, or linkage to an update one of these, wherein an instantiation of the request is preserved as a record into the ensemble of electronic communications record. Accordingly, regardless of how distinctly amorphous a RCS Network manifold topology may be, there are acceptable centralization mechanisms providing access to the public, to the commenters, and to referent owners. There are also instances and embodiments wherein a referent owner will post and selectively broadcast information about his respective referent, with the intent to receive and/or collect comments, ratings, or reviews thereto. Furthermore, it should be appreciated that RBA, especially as applied to internal organizational RCS Networks, may be according to respective managerial status, restricted to like professionals, kept within the confidentiality of project co-workers, only open to investigating auditors, or any other RBA scheme.

According to a different instant embodiment of the RCS Network, the tag, that is designating an authenticated profile relationship between the commenter and the referent owner, relates to an attribute of the respective record and the attribute is selected from the list: the commenter, the comment, the referent owner, the referent, the relationship, the access, a profile associated with a mobile device facilitating the access, a profile associated with a user of the mobile device, any word combination within the comment, and any synonym descriptor of the aforesaid.

According to yet another instant embodiment of the RCS Network, the comment, which relates to referent of different owner, includes at least one expression compliant with a vantage selected from the list: an unsolicited descriptor, a solicited descriptor selected from a predetermined set of descriptor choices, a valuation, a feed-back assessment, a feed-forward suggestion, a grade, a survey, a rating. a vote, a free-form text, an audio segment, a graphic, a symbol, a video segment, a hyper-link, and a linkage pointing to a localization for a different referent.

According to still a further instant embodiment, the RCS Network further includes, for a designated grouping of relationships between at least one commenter and at least one referent owner, a characterization of interactions there-between which are represented by at least one valuation selected from the list: indicia, statistics, metrics, calculus, topology, a filtered subset of any of the aforesaid, a convolution between any of the aforesaid, any information phase-transition dynamics thereof, a graphic summary thereof, an alternate format representation of any of said relationships, and a dashboard thereof. It should be noted that these same characterizations may be applied to tag, Vtags, for characterizing a specific commenter, etc. In the present context, a dashboard is a data and record view manager when considered from the side of the ASQ and RCS Network service providers, and may be provided to comment owners and to referent owners as an interactive tool. Preferably, an exemplary Referent-Centric Social Network further includes search engine access to characterization of interactions, such as between records, between owners, between tag (or equivalent) combination, or the like, and even between arbitration protocol rules.

According to yet another instant tagging-related embodiment of the RCS Network, RCS allows concentration on specific aspects between profile relationships and related referents, hereinafter called “Perspective”. This is made by filtering relevant Vtags/RelTags and/or minimizing the user profile to those specific details, thereby making a social platform dedicated to a respective subject.

Perspective: Today, we are accustomed to a view of social networks as having fixed threads of discussions, which are preferably centric to some topical cluster. Often, particularly in unmoderated public discussions, unrelated items and off-topic divergences dilute the informational value of the discussion. Furthermore, even for pristine topic-focused discussions, most of us are only interested in certain aspects of these threads or in the content of these threads according to our own particular purpose. Perspective allows a limited filtering of a specific domain of one or more threads in order to extend and deepen our observations of logical connections, sub-topics, and their details. Thus, for example, we may filter a large domain of common topic threads to segments including comments by our personal friends or by individuals of a particular validated credential listed in their respective profiles. These filtered results then allow us to quickly get to a level of detail that is more appropriate to our respectively motivated curiosities. Accordingly, applying a perspective type filtering provides a more focused user experience and a more professional data extract, in accordance with our limited interests. Further advantages are in facilitating professional social networking, an ability to efficiently distribute or collect surveys, discussions, and updates, any of which are the basis for summary publications. Accordingly, perspective filtering can be applied to enable a variety of instantly moderated discussion extracts.

Alternately stated, perspective tagging filtering onto a social network actually enables defining at least one context for information in every posting, survey, or discussion that a profiled user participates in; allowing characterization of posts and of contacts into categories such as, for example, posts on labor issues, posts by children, posts by nationality, posts by language, or the like, all in accordance with Tags, VTags, RelTags, combinations thereof, and the like. Additionally, perspective empowers a user with an ability to bind similar posts into one category, and to elaborate, expand, and apply RelTags.

By example, a large plurality of threads in a discussion, forum, or plurality thereof can be RCS tagging tuned to “School Network Perspective” of some local town, where users profile will be minimized to those having relevant profile detail of relationships with that school, such as (using a glyph-tag “&”) &Student, &Parent, &Manager, &Supervisor to filter so that the only referents appearing in that platform will be the “School” related posts and surveys that “appropriate” users contributed to.

Now, embodiments of a Dashboard allow a respective referent owner to manipulate exposure of the comments related to the referent. The Manipulation may be used to define and/or display the statistics calculation of the records (such as definition of time interval for included records or to provide further masking of the above interactions for publication purposes of for hiding some metric which may imply bad serviceability characteristics or for revoking old comments that cause low ratings. The Dashboard also provides the commenter a facility for respective visualization, access, and control of his comments, his personal profile, his activities on the RCS, and his personal ratings and grades and any other interrelated social network activity.

According to an additional instant embodiment of the RCS Network, the comment, which relates to referent of different owner, includes reference to at least one specific referent-relevant subset and the reference is selected from the list: at least one portion of the referent, at least one coordinate within the referent, a coordinate offset within the referent, at least one data structure vector based within the referent, a cross-reference to an alternative juxtaposed referent, and any combination of the aforesaid. Referent specific portions may be a chapter of a book a scene of a movie an intersection in a city, a food item on a menu, a member of a pubic assembly, or the like.

According to another additional instant embodiment of the RCS Network, the interactive electronic communications access, between the commenter and the referent owner, is selected from the list: Peer to Peer (P2P), Virtual Private Network (VPN), chat room, web portal, mobile application, bulletin board, forum, HTTP, HTTPS, SSL, SSH, Web service, and Remote Procedure Call (RPC). Preferably, an instantiation of the electronic communications is preserved as a record into the ensemble of electronic communications records; thus, for example, each response from a referent owner to a referent designating commenter may constitute a new RCS Network record; or, according to the policy discretion of the ASQ standards, a plurality of mutual responses (a chat or email-type exchange) between a referent owner to a referent designating commenter may constitute a single new RCS Network record.

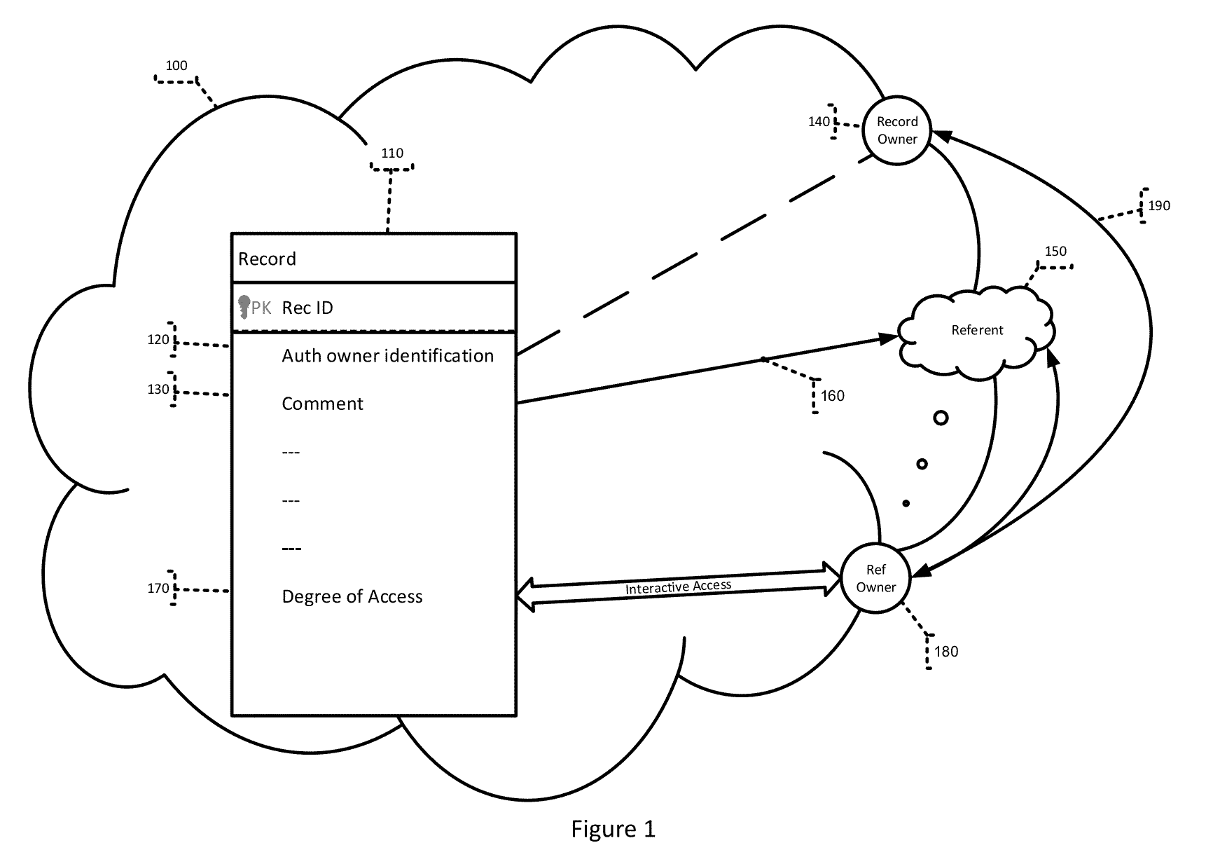

Turning now to the drawings, FIG. 1 shows a specific embodiment of the instant invention relate to referent-centric social networking, templates useful as a generic format for interrelated electronic records which are substantially disbursed in an amorphous abductive data network (100), and a typical record (110) of these interrelated records includes (A) an authorized owner identification (120) of the record, (B) a comment (130) by the owner (140) that the owner deems relevant [and having at least one third party authenticated profile relationship (190) between the comment owner and the referent owner] to referent by a different owner (150), (C) linkage (160) pointing to a localization of the referent, and (D) a degree of access (170) to the comment of the record, wherein the access includes an interactive access (180) for an owner of the referent.

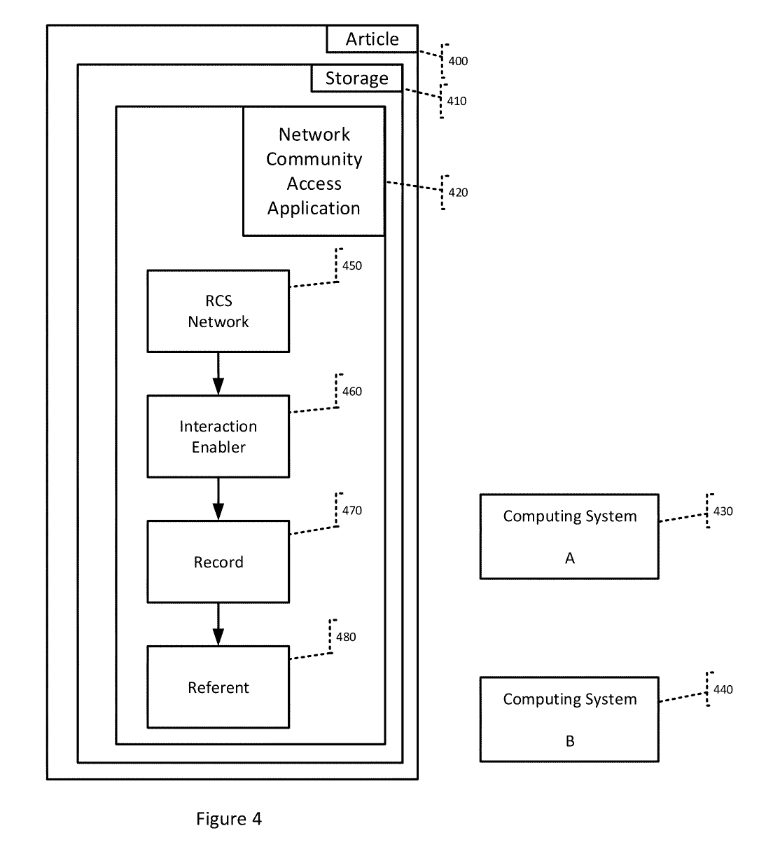

In slightly expanded detail, this referent-centric social networking embodiment includes templates useful as a generic format for interrelated electronic records. (See FIG. 4 for an alternative exemplary instantiation of RCS Networking records.) These records are typically substantially disbursed in an amorphous abductive data network. Given the current size of server farms and similar mega-data enterprises, the network's geographic distribution need not be a significant characterizing factor, nor need the apparent non-plurality of copyright owners of the records; rather the amorphous nature of the network, from the perspective of data organization, dominates. Furthermore, an authorized owner identification of the record relates to a systems knowledge of the author and/or conveyor of referent in the record (an owner), such as having a record of identifiable aspect related to the authoring of a comment—including, for example, the name or the author, the network location from which his comment was posted, and an external validation of the author's relationship to a referent (such as goods or services) upon which he is posting a comment. The expression “a comment by the owner that the owner deems relevant to referent by a different owner” is, by supposition, an abductive item. Linkage pointing to a localization of the referent is sufficient to locate the referent in this network or in a related accessible network. A degree of public access to the comment of the record is an extension of the abductive facility which allows the network community to be open to any individual or automaton abiding by community rules. An interactive access for an owner of the referent relates to a facility whereby some minimum dialog between abducting entities is facilitated.

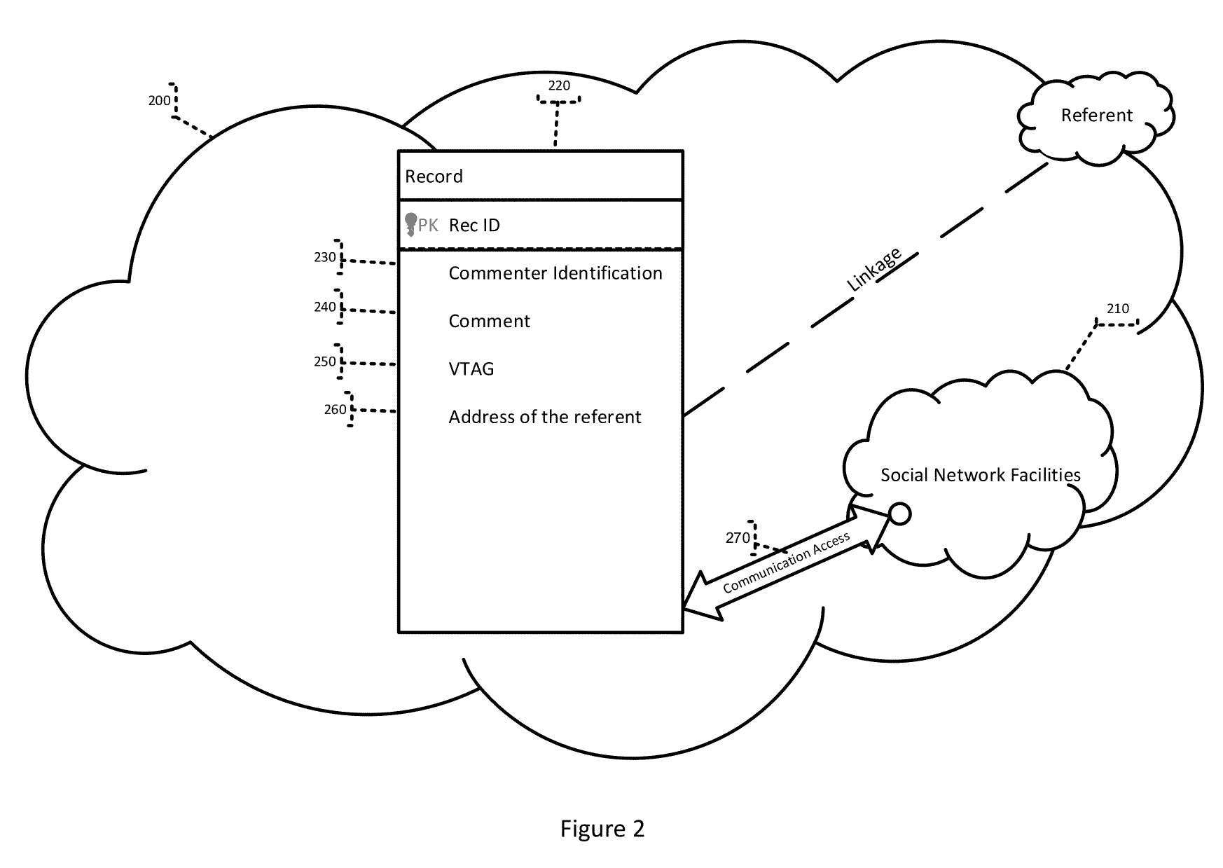

Turning to FIG. 2, broader embodiments of the instant invention relate to a Referent-Centric Social Network, for improved authenticated services quality validation, the network comprising an ensemble (200) of electronic communications records and social networking facilities (210) thereto. A typical exemplary record (220) of these records has: (A) a validated identification (230) of a commenter; (B) a comment (240) owned by the commenter which relates to referent of a different owner, wherein said comment includes at least one Vtag (or equivalent) (250) designating a third party authenticated profile relationship between the commenter and the referent owner; (C) linkage (260) pointing to a localization of the referent; and (D) electronic communications access (270) to the comment. For a large majority of the records, the respective social networking facilities include: (I) an interactive electronic communications access between the commenter and the referent owner, (II) a commenter centric broadcast of the comment to a substantially Vtag (or equivalent) appropriate group, (III) a referent centric aggregation of related comments from a substantially Vtag (or equivalent) appropriate group, (IV) a network centric summary of any of the aforesaid for a substantially Vtag (or equivalent) appropriate group, and (V) a dynamic view of any of the aforesaid.

Very simplistically viewed, this referent-centric social networking embodiment includes a very large plurality of electronically interrelating records having respective third party authenticated profile relationship recorded therein; and, for those having access to a subset of the records, respective social networking facilities pertaining to the records. It is a combination of third party authentication and social networking facility which allows instant embodiments to provide the aforementioned “Advantages, Objects, and Benefits.”

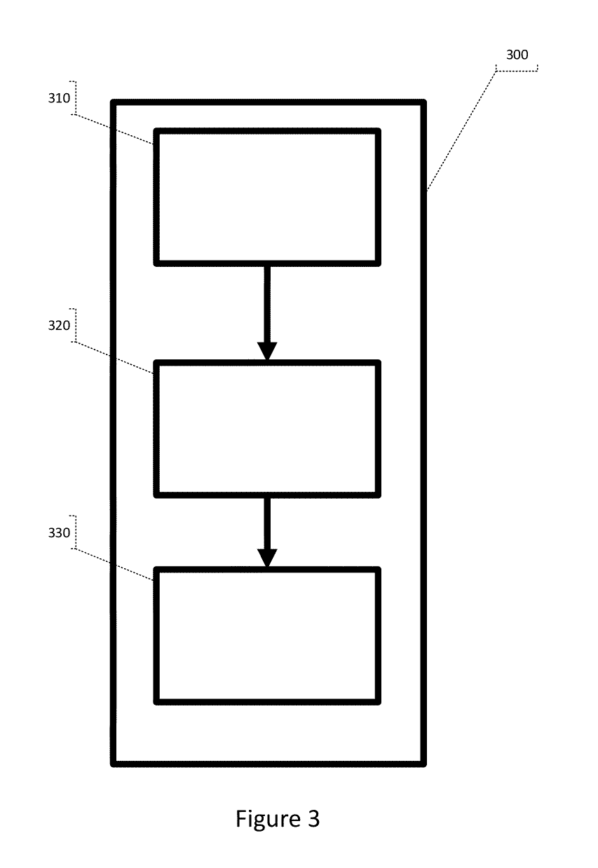

Turning to FIG. 3, further embodiments of the instant invention relate to a Referent-Centric Social Networking Method, for a service provider improving authenticated services quality validation for an ensemble of electronic communications records, the method (300) comprising: (I) enabling (310) development of an amorphous electronic-communications topology manifold; (II) for a commenter related electronic-communications activity therein, performing (320) abductive logic relevant actions between (ONE) records respectively including therein (A) a validated identification of a commenter, (B) a comment owned by the commenter which relates to referent of different owner, wherein said comment includes at least one Vtag (or equivalent) designating a third party authenticated profile relationship between the commenter and the referent owner, (C) linkage pointing to a localization of the referent, (D) electronic communications access to the comment, and (E) respective social networking facilities, and (TWO) the respective referent; and (III) arbitrating (330) basic set theoretic binary relations among the records in the ensemble.

In slightly expanded detail, these referent-centric social networking method embodiments relate to an amorphous electronic-communications topology manifold; to abductive logic relevant actions between records (as heretofore described) and their respective referents, wherein the records have a localization in a computer-readable media; and arbitrating relations among those records using a policy or protocol in force by an RCS Network administrator, wherein the determination and classification of inter-record relationships substantially follows set and subset type operations for tags, combinations of tags, validity of tags, and the like (as is explained elsewhere). It should also be noted that the manifold may be enabled in any configuration from a centralization of one or more archival or server-farm type installations to a fully distributed peer to peer type storage cloud of mutually cooperative installation of disparate sizes. Accordingly, while records and referents have owners, embodiments of the method develop groups of related records where there are no group owners.

A feature of particular value that occurs in the course of RCS Networking is the instant formation of groups. These groups are the result of convolving mutually related Vtags with respective user restrictions of accessibility and visibility. Having preformed such convolution, a member of the in the fly group may instantly broadcast to the members of that group. This is an instant crowd-sourcing facility.

According to one variation embodiment of the method, enabling development of an amorphous electronic-communications topology manifold includes (A) from the ensemble of electronic information instantiations having logical referent relationships there between, extracting an electronic address for a commenter of an instantly specified instance therein; and (B) establishing a conduit for electronic communications feedback to the commenter, thereby facilitating feedback and/or dialog between the commenter and the referent owner. Preferably, establishing the conduit includes verifying a mutually compatible information security protocol there-between. According the respective arbitration rules, a tag (or equivalent) of the referent owner may block, postpone, queue, store, or hide a notice of a comment. According to an alternate type tag, a referent owner may seek out or call for comment about the referent, and likewise these may be record owners having tags to block seeing the request, etc.

According to another variation embodiment of the method, enabling development of an amorphous electronic-communications topology manifold includes, from the ensemble of electronic information instantiations having logical referent relationships there between, incorporating into the ensemble at least one item related to the respective referent and the item is selected from the list: a text segment, and audio segment, a graphic segment, a video segment, a model, a product, a product manufacturer, a product vendor, a service, a biometric indicia, a service provider, an employer, a geographic location, an event, a news item, identification of a person, identification of a group of persons, identification of an organization, identification of an enterprise, identification of a group of enterprises, an advertisement, a distribution agency, a substantially specified fragment of any of the aforesaid, any combination of the aforesaid, and assigning a probability threshold strategy applicable for a similar referent instantiation. All of these are examples of categories used in learning strategies and in learning strategy preparation, whereby a referent may be “set theoretic” joined or linked with knowledge of detail of pertaining to the referent or knowledge of detail pertaining to a class that the referent is a member of.

According to a further variation embodiment of the method, enabling development of an amorphous electronic-communications topology manifold includes (A) accessing a large plurality of at least two types of related electronic information instantiations wherein the types are selected from the list: (i) content to content, (ii) comment to content, (iii) content to comment, and (iv) comment to comment; by (B) assembling indicia of respective owners of the electronic information; by (C) for the related information, clustering characterization of the owners using the respective indicia; and by (D) therewith facilitating electronic communications between respectively proximate owners.

According to still another variation embodiment of the method, performing abductive logic relevant actions includes certifying a validity attribute between the referent owner and the respective referent.

According to many instant embodiments, an arbitration protocol (which may be a predetermined policy, embodied in an ASQ agreement, a dynamically changing rule set, a heuristic, application of a fuzzy logic, etc.) is used to resolve conflicts of visibility, accessibility, or comment-ability between the commenter and the referent owner; likewise, to resolve conflicts of criteria between any of the commenter or the referent owner and their respective RCS Networking associates and the ASQ policies of the RCS Network administrators. Typically, the arbitration protocol is applied pair-wise as potential conflict, collisions, or discontinuities occur, such as by the creation, addition, modification, or deletion of a record.

Turning to FIG. 4, embodiments of the instant invention also relate to an Article (400) comprising a non-transitory tangible medium (410) encoding computer-readable instructions (420) that, when applied to one or more computers (430, 440) under the control of an Internet Service Provider (ISP) or of an applications server, instructs one or more of the computers: Mutatis mutandis—as is understood by the person of the art—(I) to enable (450) development of an amorphous electronic-communications topology manifold of a Referent-Centric Social Network; and (II) for an electronic-communications activity therein, to perform (460) abductive logic relevant actions between (ONE) records (470) respectively including therein (A) a validated identification of a commenter, (B) a comment owned by the commenter which relates to referent of different owner, wherein said comment includes at least one Vtag (or equivalent) designating a third party authenticated profile relationship between the commenter and the referent owner, (C) linkage pointing to a localization of the referent, (D) electronic communications access to the comment, and (E) respective social networking facilities, and (TWO) the respective referent (480).

According to a variation embodiment of the article, the respective referent (to the instant exemplary record) is selected from the list: an advertisement, a news item, a currency exchange rate, a stock price, a bond price, a commodities price, a financial market related announcement, an e-commerce event, an official notification, a news item, a political announcement, a press release, an election notice, a public comment, and a discussion.

According to another variation embodiment of the article, the instructions (applied to one or more computers) include a respective electronic communications protocol portion compliant with an associated authentication server and a mobile device application performing one of the relevant actions.

There has always been a need for potential service receivers to get a feedback about a service provider and the service quality provided. This feedback is most relevant when it is from those who have already received services from that service provider. According to the ASQ concept, an honest service provider is willing to expose service quality to potential service receivers by allowing the potential receiver to review feedback from former service receivers. The potential service receiver will want to be certain that this feedback does not include feedback data fabrication by the service provider nor by agents of the service provider. Furthermore, for the honest service provider, allowing potential service receivers to appreciate responsiveness to feedback and improvements in service quality is also desirable. An improvement in service receiver satisfaction over time is a noteworthy advertisement for the service provider. In this context, where a service provided is a referent, when a service receiver is a commenter with a validated identification and where there exists an authenticated profile relationship between the commenter and the referent owner, then the potential service receiver is most likely to trust, believe, and rely on the comments, acknowledgment of satisfaction, and problem-situation resolutions. Essentially, in the context of looking for a services provider of appropriate quality, access to appropriate RCS Networking records represents a desirable improvement for such decision making, partly because an RCS network is a reliable feedback platform for service receiver comments. Furthermore, the service provider will not be exposed to the perils of negative invalid comment attack by competitors and their agents, and the service provider will be protected from the harm done by irrelevant feedback (such as the misuse of present art service-quality feedback forums to advertise irrelevant issues, pornography, political issues, etc.). Furthermore, although some on-line retailing platforms (such as eBay™, Amazon™, Groupon™ etc) provide some sort of authenticated feedback platform, these platforms are under the supervision these respective on-line retailers—so the potential customer may always have cause or suspicion to be skeptical.

Thus, for instant invention embodiments, ASQ (Authenticated Services Quality), an exemplary attribute subset of referent-centric social networking, relates to validation of subjective information. For example, the validity of an opinion of a customer about a merchant depend on being able certify that the customer as having some commercial relationship with that merchant; likewise, the validity of a users opinion about a product depends on being able to certify the user having rented, owned, found, or borrowed that product. Accordingly, an information data manifold having comments, opinions and discussions will be judged as providing a quality of service to answer information queries according to the degree of authentication that the information therein carries.

As mentioned above, Abduction is a type of inference that assigns special status to explanatory considerations. Paraphrasing Igor Douven and others, “In inductive reasoning, scientists—principally concerned with theory formulation—attempt to discern general, stylized facts common to specific cases. These commonalities form the basis of a theory. In deductive reasoning, scientists—also principally concerned with theory testing/falsification—generate hypotheses from a theory and attempt to test its applicability to several cases. In both deduction and induction, the author's principal concern is the theory, not any specific case. By contrast, abductive reasoning relates to a practical mission-objective oriented person who is more interested in a specific case within an area of operations or within a timely general problem. Facilitating abductive reasoning improves attempts to explain the dynamics in the specific case. One problem is that—all too often—a decision maker simply relies on intuition and common sense. Another problem is that his areas of operation typically include innumerable toxic opinions and personal bias factors, which in turn perturb recognition of dynamics that are hidden, anomalous, and counter-intuitive. Hence, proceeding from Charles Peirce, Ian Shapiro, and others, a “mindful” abductive reasoning also entails drawing from established scholarly theories (among other sources of perspective) to inform the process by which we come up with explanations of and interventions in complex cases. Sometimes the theories we draw from are complementary and help us fill out a rich description or picture of our area of operations. At other times the theories will be contradictory, and we'll need to think through whether one seems to better describe what we see on the ground. In all situations, the theories we draw from will help us establish connections and potential connections between stakeholders, organizations, and other factors, variables, and dynamics that we simply would not discern using our intuition or common sense alone.”

This seems to be the situation for the ordinary decision maker who is considering the opinions and experiences of others to bias his own decision making Simply stated, in the context of embodiments of the instant invention, facilitating Authenticated Services Quality (ASQ) knowledge reduces decision risk for a preponderance of ordinary world abductive tasks because it filters out some aspects of the toxic opinions and personal bias. Alternately stated, ASQ knowledge helps make the accessible commentary more reliable, not because the respective authors do not have personal opinions and biases, but because it helps validate a higher degree of certainty that the authors have an actual relationship with the referents that they are commenting on. ASQ knowledge may be considered as a dynamic certification based filtering scheme for knowledge of various metrics of incompleteness, granularity of scope, and degrees of detail.

Therefore, according to a significant class of instant invention embodiments, performing abductive logic relevant actions includes ASQ certifying a validity index between the authorized owner and the respective referent. As will become apparent, while the index is sometimes a simplified yea or nay, the index allows multiple categorical memberships which in turn may be include multiple dimensions of validity indexing and non-integer quantification ratings therein. It should be noted that there will be many owner-referent tuples that can not be certified. These tuples may be arbitrarily set to null (ASQ un-certified), maybe set according to a general reliability index for the owner, may be set according to a specific reliability index for the owner with respect to this category of referent, may be modified according to a semantic review of the content (downgrading certification for comments or owners making comments with impolite language instances-or-re-normalized for owners whose language is substantially homogeneous—for example for an owner who consistently comments that all items are variations of OK, etc.), or the like.

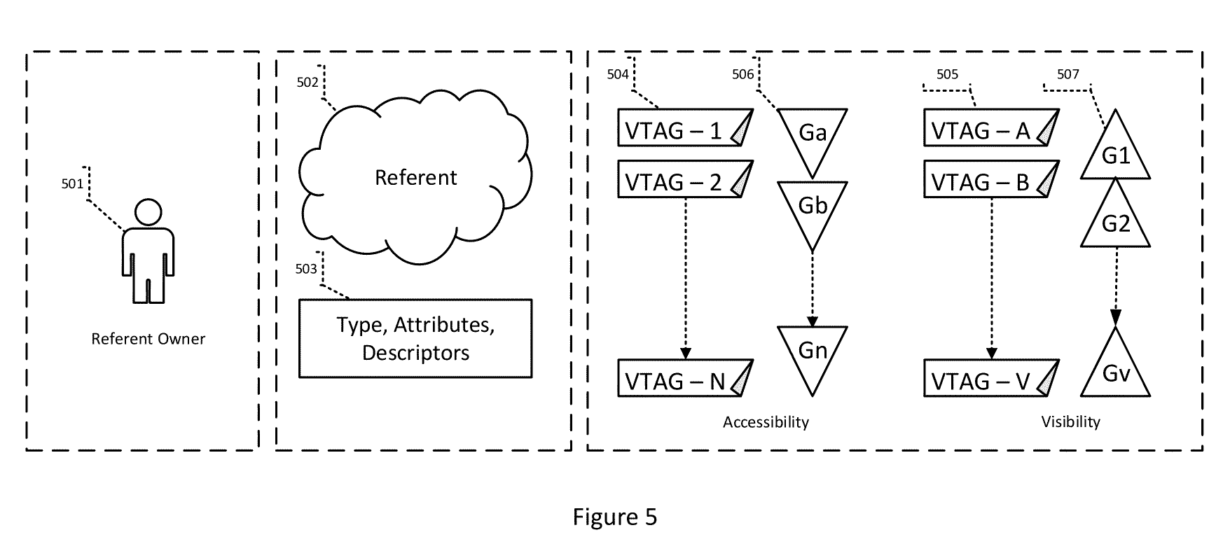

Turning to FIGS. 5-9, they show schematic views of generation events of an ASQ RCS Network record. Turning to FIG. 5, a referent owner policy is shown wherein a referent owner 501 such as an exemplary pizza shop's owner, wherein this referent 502 is the pizza shop which is described by (tags) general type, attributes, and more specific descriptors 503 such as name, location, phone number, food service license, etc. The referent owner defines a policy of acceptable relations with commenters and with viewers, which comprises a list of at least one Accessibility Vtag requirement 504 for potential commenters on the referent type, attributes, and/or descriptors; and on the other side of the policy there are Visibility Vtags requirements 505 describing who may view comments on the referent. Then, the referent owner defines at least one group of commenters, as those groups having any predefined boolean combination of 504 Vtags, and likewise defines boolean combinations of 505 Vtags to define groups who will have access to view these comments. It should be noted that 504 and/or 506 can relate to specific individuals—whom the referent owner accepts without any substantial profile relationship—such as by name, by professional certification, by organizational membership.

The referent owner can in addition to his Vtags filtering policy, to define non-authenticated groups of peoples that can access 506 or see 507 the referent comments, this groups are subjective user defined groups that the referent owner deems relevant to his referent, this can be his colleagues, some other friends, some Facebook™ known group, or any group in the context used by social networks.

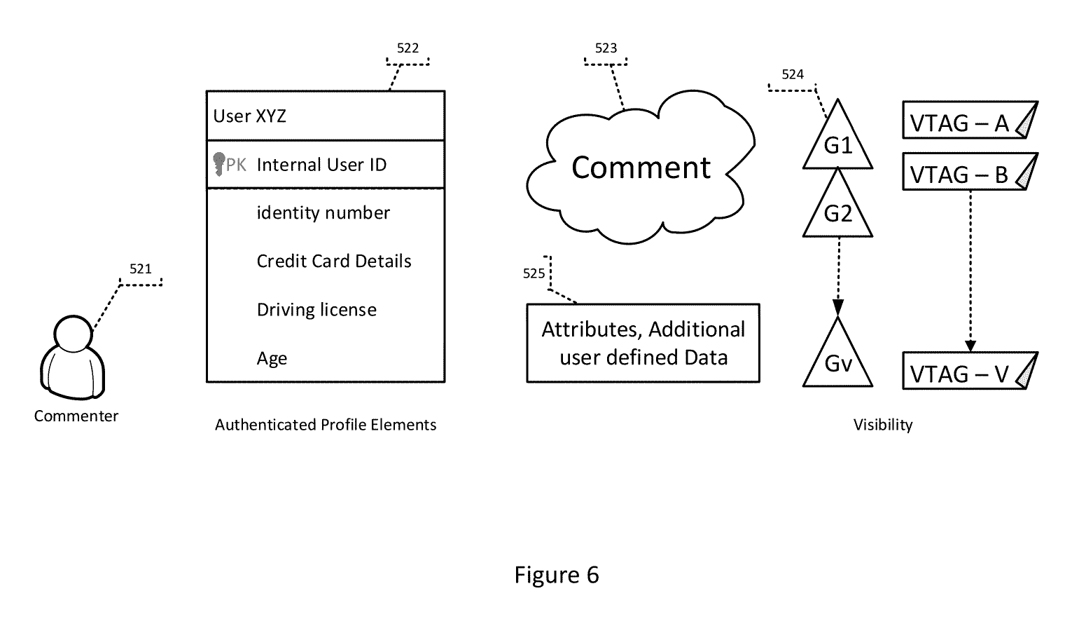

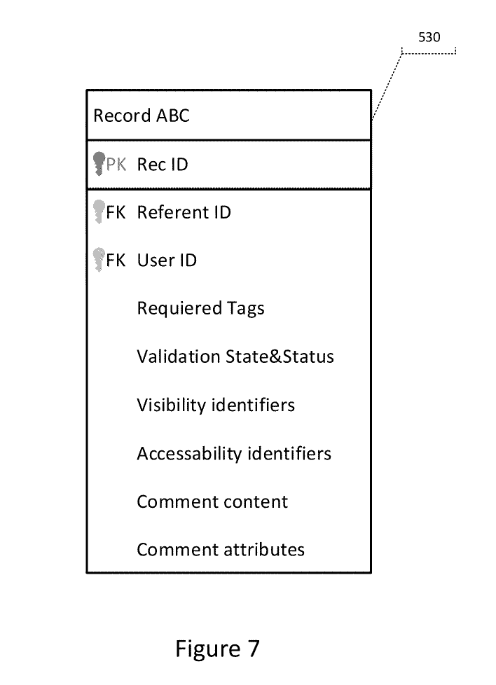

FIG. 6 is describing a commenter 521 who has a profile 522 of authenticated profile elements which will then be used to acquire Vtags to validate user relationships with the referent 502; and these validated relationships give credibility to a comment 523 that the user may make about the referent, and likewise permits the user to specify groups 524 which he would like to allow access to his comment. Classification of the comment then gives rise to respective attributes 525 which may be used allow matching of the comment to the accessibilities of other users from those groups. Thus, FIG. 7 illustrates an exemplary record 530, substantially as characterized herein-before, which is a convergence of properties from FIG. 5 with FIG. 6.

Turning to FIG. 8, a user 541, of determinate “VTagged” profile, searching over a collection of 530 records, is constrained by A1 A2 accessibilities and V1 V2 are validated tag properties (which are convolved to constitute a ASQ policy arbitration example 542) that allow a Referent Ratings & Statistics view543 to show data and comments 544 545 546 547 548, 551, 552, 553 and to refrain from showing other metrics 549, 550. However, turning to FIG. 9, a user 581 (having a broader accessibility permission 582 than that shown in FIG. 8) is allowed more data visibility, such as to conditions 583, profit 584, and another variable over time 585.

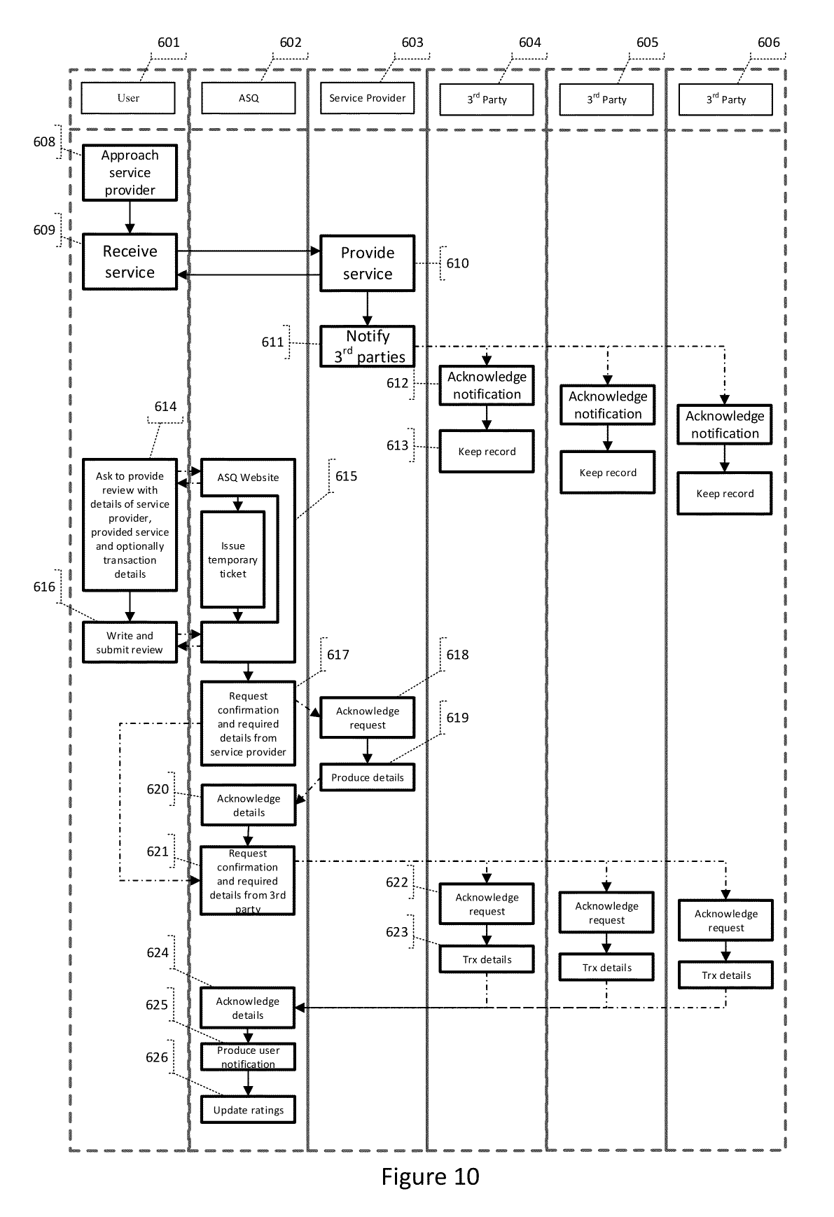

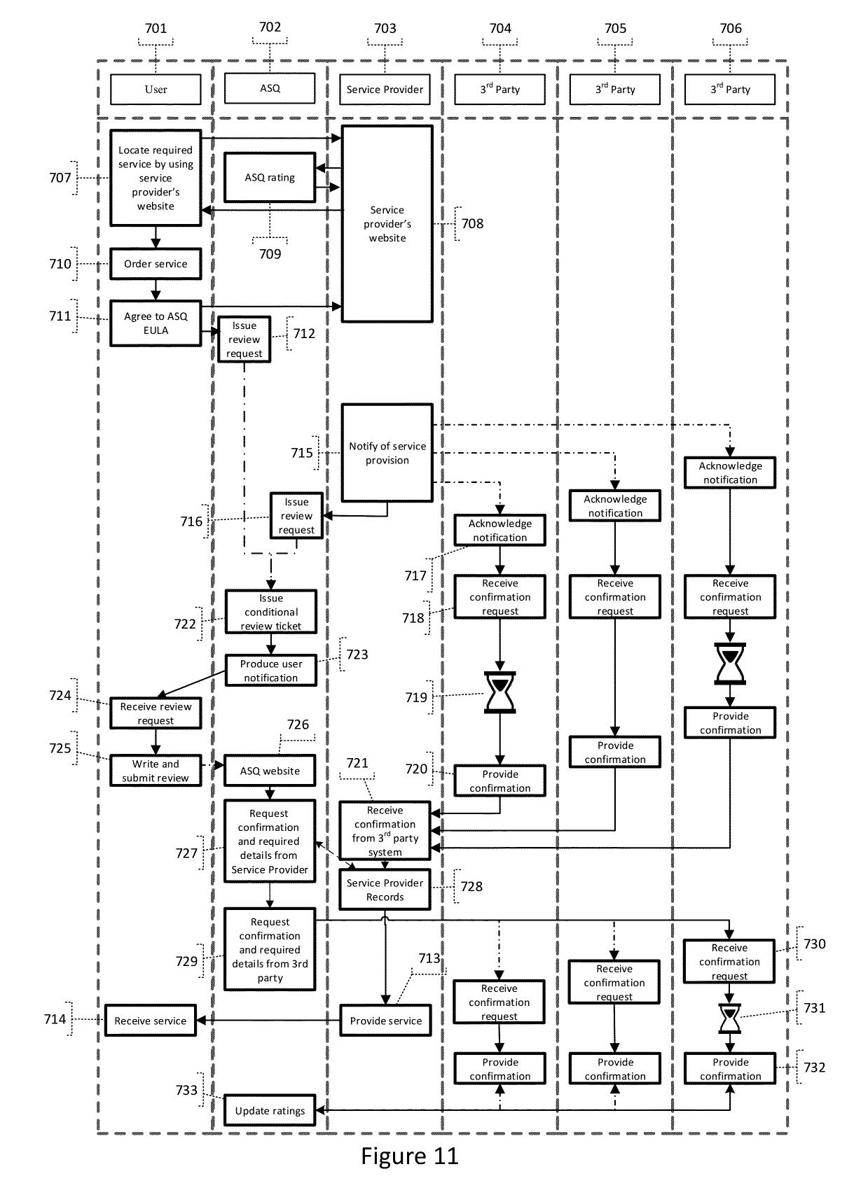

FIGS. 10 and 11 illustrate schematic views of other RCS Network record creation processes, wherein FIG. 10 shows a chart for a user driven process for creating a record independent by any referent owner or service provide and FIG. 11 shows a chart for another more integrated referent owner and ASQ RCS network way to create a record.

Turning to FIG. 10 (user driven process for creating a record), a chart is organized with six columns, respectively, for a user (601), ASQ (602), a Service Provider (603), and three different third parties (respectively 604, 605, and 606). According to a simple exemplary scenario, the user approaches the service provider (608) and the user receives a service (609) from the service provider who is providing the service (610).

In turn, by providing the service, the service provider notifies (611) third parties, which each respectively acknowledges the notification from the service provider (612) and respectively keep a record of the notification provided by the service provider (613). Examples of the service may be renting a car, receiving a medical examination, accepting a position of employment, purchasing a package of stocks or bonds; and, mutatis mutandis, any permanent or temporary use of (or access to) physical or digital goods or physical, and any permanent or temporary use of (or access to) digital services.

Therefore, in the event that the user is solicited to comes forward to provide a review (614), then the user relates to ASQ who provides a temporary ticket (not-yet validated user RECORD to include the review details) (615)—which in turn allows the user to start and write a comment (616) about the service received. Accordingly, ASQ requests confirmation and details (617) from the service provider that receives the request (618) and provides transaction details about the event between the user and the service provider (619). Now, ASQ having received these transaction details (620), ASQ in turn seeks out independent third party/parties validation of the event (621) who in turn provided validation tag details (622 623). ASQ may now acknowledge the details (624), provides a notice of acceptance to the user (625), and ASQ may now use the user review to update rating on the service provider (626). Note that according to this scenario (via 618 & 619) there is service provider cooperation; alternatively, ASQ may approach the user (614) to do the process.

Turning to FIG. 11 (another way to create a record), a chart is organized with six columns, respectively, for a user (701), ASQ (702), a Service Provider (703), and three different third parties (respectively 704, 705, and 706). User comes to a service provider website (707), and sees an ASQ certified user satisfaction data summary on the service provider website (708), which is constantly (or periodically) updated from ASQ's records (709). The user orders a service (710) from the service provider AND the transaction includes a data and identity sharing agreement for the user to be a new user at ASQ (711), or user may indicate that he is already an ASQ registered user or the user may decline—which are respectively parts of the set theoretic logic policy (exemplary binary relations among the record). Thus, in the case of user agreement, ASQ receives a review request (712) which can be received even before any service is provided (713) and accordingly received (714). Substantially as the service is provided or subsequent thereto, notification (715) is issued to update third parties; and just as the user may request a review, likewise the service provider may request a review (716).

Now there may be two substantially simultaneous processes.

One process (715-721) is that the notification (715) of transactions processing or processed by the third parties respectively with each acknowledging (717), receiving confirmation (718), and synchronously or asynchronously clearing the transaction (719), to which eventual confirmation is provided (720)—so the confirmation is received (721).

The other process (722-729) provides that once a conditional review tick has been issued (722), then a user notifications issued (723) such as an email or an SMS or an instant notice to a mobile device, then the user receives the review request (724) and the user provides a review (his comment) (725). ASQ receives the user review (726), optionally request (727) confirmation records (728) if ASQ does not have sufficient Vtag validation of the proficient relationship, to which ASQ requests transactions specific verification (729) even if ASQ has knowledge that there is a profile relationship between the user and the service provider, that knowledge does not necessarily include confirmation of this transaction. Third parties respectively receive the request (730), eventually are capable of confirming the validation or not (731), to which the third parties reply to ASQ (732)—allowing ASQ to update the rating (733) the pending of which is now approved and validated.

A prerequisite domain for many embodiments of referent-centric social networking is a knowledge network, which is a preferably large plurality of digital content having commentary on elected items therein. In this context, a knowledge network may include databases, libraries, audio content, visual content, text, hypertext, and the like, whereby commentary and reviews collectively create a discussion about specific location in the knowledge network, larger sections in the knowledge network, or even entire aspects of the knowledge network—as per the prior definition of referent described herein.

There are many more specific examples of digital content, such as digital books, web pages, sound recordings, films, images, and structures of data from nature, science, technology, commerce, models, simulations, and artistic creations. Each such example is characterized by having (A) header information describing the content as a whole and (B) a plurality of separable items therein. A simple example would be an image of a font of a single phonetic character, where (A) the header may include information referencing at least one creator of the image, at least one date when created or updated or viewed or referenced, an image identifier for logical or physical storage of the image, a quantification of the digital size or resolution of the image, reference to data formatting of the image, and categories, tags, classifications, or key words relevant for characterizing the image, and where (B) is data content, substantially according to a Data Normalization formalism (such as Boyce-Codd, Domain/Key, Partitioned, or the like). It should be noted, however, that larger aspects of Data Normalization may deteriorate as threads, even in a two author dialog of comments and responses, are retracted, withdrawn, or allowed to expire from external perusal.

Other significant aspect of many instant embodiments of referent-centric social networking relate to facilitating Authenticated Services Quality (ASQ). ASQ relates to systems, strategies, and heuristics which facilitate and aggregate data wherein the data includes evaluations of services and of goods provided with service (or merchant) obligations. The ASQ authentication aspects relate to validation that the evaluations are derived from actual customers, recipients, or at least from relevant certified professionals. ASQ embodiments are an exemplary attribute subset of referent-centric social networking.

According to one embodiment, ASQ is established on central electronic communications systems that provides reliability for all kinds of transactions, particularly to integrate third party validity between two transacting sides. The third party (and ASQ communications provider) is essential to certify details—to provide linkages between two sides. Details relate to the identity of the parties and/or to particulars within a transaction there-between. Furthermore, after details are certified to the satisfaction of the ASQ provider, then notifications by or from ASQ provider facilitate public comments between the parties regarding the parties and/or the transactions. For example, a buyer can comment about a seller after the transaction between buyer and seller has been certified. This prevents the seller from commenting about his own worthiness and prevents a non-buyer from praising or degrading the seller's reputation.

Another example is a transaction between a person and a hotel, where payment is via a credit card company. Accordingly, a third party certificate agent may be working directly with the credit card company, such that if the credit card acknowledges that there was a transactions—then this is accepted by the certificate agent to say that the person booked a reservation at that hotel, and/or used the reservation.

Similarly, services from a government agency may have increasing levels of validation if the recipient or applicant is from the respective location or region. His rating of quality of services rises to to a threshold of authenticity when it can be certified that he is in fact registered for such a service, and then his comments and adductive conjectures are accepted as an authentic feedback.

Likewise, in an example of health services, authenticating that a commenter is registered for such health services, has been recommended for such health services, he received such health services or has paid for such health services, elevates the comments and evaluations of such an individual to that of authentic feedback.

Once the party is certified as authentic, then (according to some embodiments) begins a process for “tagging each attribute that is certified” (Vtag) within the comments, to the degree that such is possible or practical. For example, a person may be an authentic member of the health service but may want to comment on a procedure that neither he nor any member of his family may have been even a potential candidate for. Alternately, the person may be commenting as an appropriate certified professional, such as a medical doctor addressing a medical procedure. Thereafter, the aggregate feedback is available publicly via any outlet—not just via the person, a central party, or the service provider.

A service provider (or seller) can not change the feedback—but he can answer the feedback or allow part of the feedback data be seen. This is interactive access. As for limited viewing, a service provider may restrict comments to over the last three years or over the last sixty days—but the viewer will see a notice indicating the provider viewing restrictions. This seems to be a fair variation respecting a possibility for service providers to improve their quality of service and therewith to improve their feedback statistics. A longitudinal presentation of feedback statistics will also illustrate the improvement, wherein a viewer will see some dramatic improvement in the service provider statics from before some problematic interval to more current servicing relationships. Similarly, a service provider may elect to allow presentation of grades but not the comments. In all cases, the recipients are validated as authentic to comment on the service provider. Symmetrically, service providers may contribute customer ratings and comments. This is broadly equivalent to credit rating, albeit for customer personality.

Having now disclosed many vantages of RCS Networking, it makes sense to share a diverse plurality of examples and of application scenarios before returning to further discussions of a more general appreciation of the instant invention, of other aspects, and of other embodiments.

First, different services involve different data processing convolutions because of variations of data availability and of data validation issues. The following categorized organizational view of exemplary services is according to a first consideration of relative simplicity for certification, validation, and/or authentication, although actual RCS Networking and ASQ implementations will certainly vary according to jurisdiction and data privacy practices therein.

A seemingly-simplest, category may include tourist services that are reserved, such as hotel rooms, hotel services, flights, car rentals, cruises, visitations to for-pay tourist sites, and the like, because there is generally a third party payment confirmation upon booking a reservation, a second confirmation upon arriving to accept the booking, and a post-service confirmation of completion of service (such as car return, flight arrival and luggage acceptance, etc.).

A next, slightly more abstract category, may include workplace issues that are typically monitored and regulated by government agencies, courts, unions, social action NGOs, and typically include a mixture of subjective and objective metrics of record (such as work contracts, wages, benefits, bonuses, penalties, tax events, employee evaluations, employment records, collective comparisons will others of similar job, records of employer relations, etc.).

Thereafter, a slightly more subjectively biased category may include health care issues that are typically inclusive of potentially unique combinations of factors which, on the one hand, are substantially unique for each individual receiving services, and, on the other hand, vary greatly according to the “school of treatment” medical care protocol (such as western, eastern, folk, allopathic, homeopathic, herbal, spiritual/psycho-suggestive, etc.) that may be trying to address that respective uniqueness. This example is further complicated by the generally broad range of avenues of care which span from ultra-public care “factories” (such as mass immunization) to ultra private care (such as personal health clinics, spas, sanatoriums, etc.).

Now, increasing further regarding subjectivity variability and complexity of verification are government services, police involvements, court involvements, penal institutions, parole protocols, and court mandated rehabilitation systems.

Finally, an exemplary last category is characterized by an innate difficulty to know if service actually occurred. This category includes such services as household repair (such as plumbing or electrical or appliance), gardening, and home cleaning, and is often further complicated by payment or tips in cash, by delayed notice of non-satisfaction (such as near-term subsequent post-repair breakdown, etc.).

Second, services between different types of relating parties often involve different modalities of feedback review, and comment. Thus, services may be from one individual to another, from an individual to an organization, from an organization to an individual, and from one organization to another organization. Accordingly, for a referent service event, a comment may have the status of a personal feedback or the status of organizational feedback (such as representing the satisfaction or dissatisfaction of an entire population of membership). This broad range of commenter status then caries validation protocol details which may involve anything from the simplicity of personal profile data to the statistical variability involved in characterizing an organizational entity, each of which then brings respective concern for degrees of certification for the accuracy of the data.

Third, typical to ASQ participation and often integral to ASQ arbitration protocols (used to resolve conflicts of visibility, accessibility, or comment-ability between the commenter and the referent owner, etc.), each service provider may elect to specify aspects (categories) of feedback on services received, then feedback visibility may be distinctive to predetermined tagged attributes (such as for medical services to allow for all certified medical practitioners access, or other Role Based Authorization standards, etc.).

A more fluid RBA may set a relational standard threshold for those validated as having given or received service for a similar transaction, which in turn may be relevant to complete reporting or partial reporting of feedback (reviews, comments, etc.), and this approach also provides a dynamic system for maintaining respective filtering standards. Likewise, just as the service provider may give limitations to access under his ASQ agreements, so to the feedback provider may specify degree of public access (such as per his respective ASQ agreement, which may be enabled as certified tags, etc.). Clearly, Conflicts between provider and receiver limitations may be resolved by ASQ arbitration in a set theoretic manner and according to final approval under a general ASQ RCS Networking policy protocol. Further resolution scenario classes may include instance wherein visibility is assigned to specific sub-population as per feedback designated tags, is assigned as anonymous for general public as option, is separately assigned for each transaction (such as on a one-feedback/review/comment-only per service transaction basis, albeit allowing for a re-edited within a predetermined time limit, or having a policy to set a different time limit according to extensions to warranty that vendor gives purchaser, etc.).

Fourth, Role Based Authorization standards may be used to established a virtual social network, such as an internal organization commentary or simply restricted like group of friends, family, co-professionals, or the like. This is another instance of implementing a policy and protocol for arbitrating basic set theoretic binary relations among the records in the RCS Networking ensemble. According, where crowd-sourcing (bad publicity) is not desirable and where conflict resolution is desirable, ASQ arbitration rules seek to limit feedback explosion, wherein an exemplary scenario structures an initial bilateral communications dialog between a customer and a vendor. Such an exemplary scenario structure may include an instant initial customer to vendor complaint expressing the situation, problem and desired mode of resolution, such as to fix, replace, return, and/or requiring apology and/or further compensations such as in cases of injury, embarrassment, loss of time, frustration, etc.; if negotiation and/or arbitration is the desired scenario or not., etc.; over what reasonable time interval (such as within. 30 day period); further feedback confirmation of resolution, non-resolution, desire to continue, etc.; and interim summary categorization (such as either problem was fixed, modified, complicated, simplified, extended, etc.). Ultimately, the arbitration must deal with a conflict between a request to allow public access or limited public (within predefined social network) broadcast and to restrict such publicity. Likewise, the arbitration protocol must take, record, and resolve such changes of public profile, commenter bias (such as his comments are almost always negative or always positive) and even to flag abuse (essentially as an ASQ Vtag). One variation for this exemplary scenario is to direct the parties to alternate conduits for direct communications (such as according to vendor, receiver, and transaction topology, verification issues, etc.). Another variation for this exemplary scenario is the addition of audio or video or picture to justify the feedback/review/comment or the response thereto. A further variation for this exemplary scenario shifts commenter status flags and Vtags from ASQ to other members of the RCS Networking community, whereby they may comment on comments (such as expressing a like or dislike vote on feedback of others, a changes the status of the feedback provider, or even a citation analysis to grade importance of commenter).

Fifth, embodiments of a dashboard and/or of graphical user interface applications (operating within the ASQ visibility arbitration protocol) present views of evolving relationships between communicators (such as by illustrating clustering, stratifying, and organizing information there-between, and by assigning visualizations to interactions characterized as indicia statistics, metrics, calculus, topology, and information phase-transition dynamics thereof. More pacifically, these may be shown on service provider web site—as ASQ certified data derived from a current RCS Networking data aggregation or sample. For example, on the vendor website or on a dashboard, a graphic may be expressed as a pop-out for any element of service provided (such as up to 5 stars or bars, a size changing icon, text, links, statistics, etc.) and the viewer may be provided with an option for potential interaction with the pop-out (such as voting like or dislike, bookmarking this entry for potential chat communications with “friends” or as anonymous, etc.). Of course, different smart style algorithms are applied to that assemble and normalize statistics (such as by weighting each person for each transaction for each voter or feedback). Various incentives may be offered to participate in ASQ in general or in a vendor or market assessment (such as by giving prizes, ranking, tokens, promotions, coupons, discounts, and/or by conveying status-titles to selected feedback-authors, etc.). Likewise, higher levels of statistics may be generated, displayed and/or broadcast (such as best seller, top ten, hot-fad-item, etc.). http secured request OR SSL (for encrypted certified request) maybe engaged to receive and to broadcast accurate feedback, and to exclude hacker altering feedback on behalf of a competitor or simply maliciously.

Sixth, while there are embodiments of ASQ RCS Networking interfaces at the user level, at the vendor website level, there is also another embodiment facility whereby public access is channeled via a web portal. While there may be virtual organization, professional society, and similar restricted (registration verifying variants), it would be in the public interest to provide an open public access portal where search on portal is open to all, notwithstanding that providing feedback/review/comment via the portal is secured—as per tags—for all interactive RCS Networking record addition, modifications, limitations, etc. Again, while individuals and vendor websites may elect their own interface formats, the public portal provides styles of first template standards for types of services, for expressing the importance of each variable according to pre-set for weights, and the like. Examples of arbitrary predetermined comparative weighting structures may include: for a hotel—comparative attention to facility cleanliness or guest services, for a restaurant—comparative attention to the importance of interior decoration or acoustic ambiance, and the like.

At still a broader level of data summary and statistics, ASQ interfaces may provide a window including characterizations of national attitude weighting or regional weighting or personality weighting, just as a typical user may be interested in viewing his own profile in the context of the collective profile of an arbitrary Vtag (or equivalent) group, such as how they compare with respect to weighing variables to give a final grade to a service provider. Furthermore, quality user feedback to ASQ is typically appreciated, especially regarding filtering feedback/comment/review (RCS Networking records) as per expressions of obscenity, pornography, racism, anti-social or criminal expression, suicidal notice, and/or any expression regarding specific group appropriateness or inappropriateness.

Continuing, regarding a structure for an exemplary public access web portal, preferably there is a registration of accounts of individuals and/or of organizations (providers)—to include profile disclosure that can accept an eventual Vtag, preferences regarding views of data received and visibility of data to others according to per tag (or equivalent) orientations, management of accounts, and ASQ arbitration policy. This, in turn, facilitates searches for services to the public (according to key words, tags, Vtags, labels to tags, linguistic clouds of synonyms to these, and by boolean logic and/or fuzzy logic relational combinations of these.

By combining registrations and ASQ Vtag feedback/review/comment, similar registrants can be stratified into comparative grades or classes, which in turn allows searchers to ask amorphous questions (such as “find me the best restaurant within a geo-region?, etc.). The RCS Networking provision of grouping of providers and crowd aggregations of individuals—is not central to any account, it is just a definition of a group sharing same (or similar) tag attributes (such as all residents of a town or all customers of a store) and the ASQ aspect is by Vtag (validation/certifications of tags). This portal then also serves as a platform for a survey of the public—where all of the voters are certified as per their respective tags—to be appropriate for the respective survey. By paradigms such as these, RSC Networking communities of seekers, consumers, and providers of like services are defined; likewise for goods, mutual interest, intellectual pursuits, entertainment, and the like.

Furthermore, registered commercial accounts (such as for server providers) respectively acquire unique ID for self and for each service provided, making the clouds of synonyms into substantial duplicates of the clusters of related tag classifications, which in turn facilitates more efficient relational query responses, especially for gathering RCS Networking records that are commenting on substantially similar aspects, portions, sub-parts, and the like. Nevertheless, asymmetries of arbitration (with respect to portal visibility differing from vendor website visibility) allow vendor to shows one filter of the site, while what the portal shows to the public may only be in the subset of what the vendor finds appropriate categories if that is in accordance with limitations of respective ASQ agreements, according to RBA, etc.

Turning now to interactive aspects of both vendor websites and of the portal, there are various scenarios pertaining to the robustness of a validity of certification, which are respectively resolved using ASQ arbitration protocols, and ASQ user agreements, and/or ASQ policies. For example, according to one scenario, a comment/review/feedback on a referent is only accessible for the duration that the referent is active, such that cancellation of transaction kills the feedback weighting in part as a comment on the transaction partners (provider and receiver) albeit by a quite different resolution scenario, a cancellation may be understood as a testimony to the virtue of either or both partners—who have resolved their mutual conflicts.

Other aspects of special interest from the portal vantage include: a facility for secondary data collection which allow feedback from various respectively relevant certified professionals (who may neither be customers, vendors, nor parties to a transaction whatsoever) and for appropriate Vtags therewith; a facility for respective service provider to be Vtag certified for a provider-specified term; aggregation as weighted averages where more recent are more relevant and/or where more important voters contribute to heavier weighting; and the like. Further aspects relate to potentially greater arbitration asymmetry considerations, such as: disparity between vendor site data presentation according to vendor discretion differing from portal site presentation for the respective vendor; vendor site weighting of data summary presentations differing from portal site or industry standard weighting of data summary presentations; respective presentation of feedback and respective opportunity for dialog between vendor and customer; portal alarms and alerts for sudden change of status, rank, voting, volume of feedback, and the like; visibility changes due to closing of account, such as to hide records of feedback or summaries of feedback, or not; potential postdated alteration of feedback by the feedback author or determination as a transcript as feedback on events subsequent to prior feedback; and the like. Of course, Vtags may entitle options to provide professional service providers (anything from doctor to plumber, etc.) a platform to advertise and/or to contract via portal, such as may be accompanied by a Vtag rating of the provider regarding the collective feedback voting appraisal of his respective service.

Seventh, further embodiments of ASQ RCS Networking interfaces are concerned with mobile communications devices and to applications running thereon or therewith. Exemplary applications may include pager for requests to a service provider; accept payment (such as via iPhone) which in turn instantly gives service receiver a feedback conduit that is ASQ certified; providing instant ASQ certified QR code (Quick Response Code) to service receiver; personal account registering of personal data, and respective facility to login via other accounts (such as to Facebook, Google, Microsoft, etc.); instant inclusion of profile tags (such as CV items, personal interests, places, age, employer, and even tags pending Vtag status—albeit preferably to be displayed annotated as not-yet-verified AND/OR included or not-included into weighted results; and the like. Another class of facilities includes modalities whereby an account owner can audit his own authentications and Vtags, which allows the user to provide conduit suggestions for authentication, to better organize his public profile, and to partition criteria of for his respective public profile viewer space according to degrees of Vtag or degrees of RCS Networking associations separation (such as detail view for close friends and summary view for distant friends or remote data collectors). Similar to a portal, a mobile user may specify alerts and alarms that he wants, their respective reporting regularity, summaries, and the like.

Thus, application for mobile devices may reflect changes of GPS location, of pager availability by proximity, by ratings, by costs, by activity, and the like; as a virtual platform for on-the-fly best fit opportunity matching. These on-the-fly requests can in turn feed instant creation of appropriate data or graphic presentation for each member according to the requested search, and the like.

Eighth, further embodiments of ASQ RCS Networking are concerned with aspects of groupings, clubs, societies, and even spontaneously arising collective certified tag user clusters (where no particular “cluster” membership is required—albeit accessibility is arbitrated according to ASQ protocols and agreements). Furthermore, as individuals may intercommunicate with other social networks, likewise clusters may become integrated with other social networks, and communications therewith may manifest as walls, public notices, sub-portals, bulletin boards, chat rooms, and the like. Clusters may relate to any boolean logic and/or fuzzy logic relational combinations among Vtags (or less preferably to include unverified tags) to form a member or user society; for example, to certified and/or not-yet certified field-specific professionals, restricted to country, to age, etc.; for targeted marketing; for for RFPs (request for proposal solicitations); event invitations and RSVP acceptance as per user communications filters therewith; and to include any self-management criteria into the ASQ arbitration for visibility, accessibility, etc.

Accordingly, a cluster may be created by searching in portal—for services—by tag×grade×status×hours of availability×schedule×location×feedback level threshold and the like, thereby allowing customers to find instantly appropriate vendors, service providers, etc. Preferably, searching portal is open to all, not just to registered members. There is added value to registered members, who may be certified in some tag, such as club member or employee of specific company or holder of particular credit card, or the like. Furthermore, there are facilities for instantiations of smart agents, such as for warning and notices about changes of rating or to search for typical clustered tag items or for your consideration as “friends of friends” of some distance, at the tag level which is more specific than at the member level.

ASQ also provides SEO (Search Engine Optimization) facility options for sponsored (for pay services for increased rating)—albeit preferably separately differentiated from standard ASQ portal search results. Groups of tag are also facile for surveys and statistics of results and of stratified profiles of respondents therein. ASQ communities can be used to create a user groups, such as for tag-specific receivers of notices, for club/society support-groups and advocacy organizations, for special interest forums, and the like.

According to ASQ arbitration protocols and respective user ASQ agreements, invitations may be sent, such as by tag collective, as coupons to tag grouping, and/or as per ASQ ranking assignment or ASQ promotions. An ASQ community (of a predetermined Vtag configuration) may stratify cluster members to grant preference for some tags, for others to get promotions (such as to help find ways to get their respective tags certified), for bringing new members, expanding clusters of friends, and the like. In this way, virtual ASQ societies may arise to accept members from tag grouping, such as by member invitations and member acceptance, as facilitated by internal organizer-managers. Clusters may include Vtag appropriate pop-ups, and other graphic data summary vehicles for groups, and including instant open format feedback about RCS Networking, to pro-actively evolve ASQ. Communities and sub-communities may be for internal communications, such as within a large company, for a virtual project grouping, answering a need for automatic language translators, to present a virtual organizational chart, and the like.

Now, returning to a more general appreciation of the instant invention, as is applicable to Description of Embodiments for examples too numerous to be listed, according to a group of instant embodiments, referent-centric social networking relates to templates useful as a generic format for interrelated electronic records which are substantially disbursed in an amorphous abductive data network. Therewith, such a record includes: (A) an authorized owner identification of the record, (B) a comment by the owner that the owner deems relevant to referent by a different owner, (C) linkage pointing to a localization of the referent, and (D) a degree of access to the comment of the record, wherein the access includes an interactive access for an owner of the referent.

According to one variation embodiment, the linkage includes at least one coordinate to a specific comment-relevant subset of the content. Examples of at least one coordinate may be a frame number within a video, a page and a line number within a text document, a polygon within a graphic illustration, or the like. According to another variation embodiment, the access includes an authorized status classification for the authorized owner identification, such as at least one verified profile-type detail about the author that may improve normal reliability of his comment. Certainly identification may include reference to a body authorizing the owner for this record or to other aspects apparent from ASQ examples (herein).

As mentioned above, another group of instant embodiments relates to a referent-centric social networking Method, which includes steps: (I) enabling development of an amorphous electronic-communications topology manifold, and (II) for an author related electronic-communications activity therein performing abductive logic relevant actions between (ONE) records respectively including therein (A) an authorized owner identification of the record, (B) a comment by the owner that the owner deems relevant to referent by a different owner, (C) linkage pointing to a localization of the referent, and (D) a degree of public access to the comment of the record, wherein the access includes an interactive access for an owner of the referent, and (TWO) the respective referent.

According to a first family of these instant method embodiments, through an open plurality of related-content events, enabling (the development of an amorphous electronic-communications topology manifold) includes for each said event (A) searching a network of electronic media for a content-fragment combination therein, and (B) transforming the searching into a comment-to-publisher of the contact-fragment transmission opportunity. Certainly, transforming may include interacting with a predetermined format item selected from the list: questionnaire, comment, quantified feedback, text message, voice message, video message, menu, bot, authorization protocol, registration protocol, privacy setting, security setting, publication delay, expiration conditions, access conditions, history segment, cross reference parameters, and any combination of the aforesaid.

According to a first variation of these instant method embodiments, searching (a network of electronic media for a content-fragment combination therein) includes facilitating an author of the comment-to-publisher to manage respective rights in a semi-autonomous communications cluster, wherein the author of the comment-to-publisher and wherein the publisher in the opportunity are members of the cluster.

According to a second variation of these instant method embodiments, searching (a network of electronic media for a content-fragment combination therein) includes facilitating an author of the comment-to-publisher to manage respective rights in a semi-autonomous communications cluster, wherein the author of the comment-to-publisher and at least one other author of a comment-to-publisher to the same publisher in the opportunity are members of the cluster.

According to a third variation of these instant method embodiments, transforming (the searching into a comment-to-publisher of the contact-fragment transmission opportunity) includes certifying an author of the comment-to-publisher. According to a fourth variation of these instant method embodiments, transforming (the searching into a comment-to-publisher of the contact-fragment transmission opportunity) includes mutual certifying between a publisher of the comment-to-publisher and an author of the comment-to-publisher. According to a fifth variation of these instant method embodiments, transforming includes an external entity certifying a publisher of the comment-to-publisher and certifying an author of the comment-to-publisher. According to a sixth variation of these instant method embodiments, transforming (the searching into a comment-to-publisher of the contact-fragment transmission opportunity) includes setting privacy parameters.

Certainly, certifying may include validating at least one indicia selected from the list: a transaction number, a payment event identifier, a receipt, a tracking code, a shopping cart reference, a check number, an invoice number, a registration number, a vendor code, a customer code, a tax code, a license number, an identity code, a product code, a service code, a manufacturers code, an XML meta tag, XML meta data, a lottery number, a promotion code, an encryption key, a catalog number, an HTTP address, an access code, a server ID, a device ID, a persistent cookie, an RFID tag, a database key, a broadcast channel, a caller ID, a membership ID, a post code, personal data, a password, an address, a telephone number, an electronic signature, a time stamp, a coordinate, a metric serving a function similar to any of the aforesaid, and any combination of the aforesaid.

Likewise, according to a second family of these instant method embodiments, enabling (development of an amorphous electronic-communications topology manifold) includes (A) from an ensemble of electronic information instantiations having logical referent relationships there between, extracting an electronic address for a representation of an author of an instantly specified instance therein, and (B) establishing a conduit for feedback to the author via the representation (such as via the author's agent, his publisher, to his private email, to his private VPN, to his public email, or the like).

According to a first variation of these instant method embodiments, extracting includes at least one item selected from the list: a text segment, and audio segment, a graphic segment, a video segment, a model, a product, a product manufacturer, a product vendor, a service, a biometric indicia, a service provider, an employer, a geographic location, an event, a news item, identification of a person, identification of a group of persons, identification of an organization, identification of an enterprise, identification of a group of enterprises, an advertisement, a distribution agency, a substantially specified fragment of any of the aforesaid, and any combination of the aforesaid.

Thus, the range of subject matter for the instant invention is much broader than the Umm example initially presented and even much broader than those taught in the Instant Application Examples. According to a second variation of these instant method embodiments, extracting includes assigning a probability threshold strategy applicable for a similar referent instantiation. This becomes reasonable when data can be appropriately characterized so that items and aspects that cannot be objectively validated nor certified may nevertheless be considered as potentially acceptable, such as when an author has an excellent record of authenticity or when the author is a professional certified in the relevant field, or the like.

According to a third variation of these instant method embodiments, extracting includes certifying the representation of the author. According to a fourth variation of these instant method embodiments, establishing includes joining the feedback to the respective referent relationship. Certainly, joining may include navigating proximate content relationships, and navigating may include such steps as aggregating a perception proximate content relationships and/or stratifying a perception proximate relationships. Proximate may be according to time of comment, according to physical location, according to similarity of profile data, or the like.

In addition, according to a third family of these instant method embodiments, performing (abductive logic relevant actions) includes (A) for a multi-author thread of recursively related electronic content instantiations, selecting a segment of the thread, and (B) messaging to an author of the selected segment. These are exemplary alerts, alarms, and notices of various importance, typically occurring in a discussion where a owner of content may already have participated in multiple comments and even an occasional direct dialog.

Furthermore, according to a fourth family of these instant method embodiments, enabling (development of an amorphous electronic-communications topology manifold) includes (A) accessing a large plurality of at least two types of related electronic information instantiations (two respective referents) wherein the types are selected from the group (i) content to content, (ii) comment to content, (iii) content to comment, and (iv) comment to comment; by (B) assembling indicia of respective authors of the electronic information; by (C) for the related information, clustering characterization of the authors using the respective indicia; and by (D) therewith facilitating electronic communications between respectively proximate authors. Thus, for example, proximate may be according to time of comment, according to physical location, according to similarity of profile data, or the like.

The present invention is herein described with a certain degree of particularity, however those versed in the art will readily appreciate that various modifications and alterations may be carried out without departing from either the spirit or scope, as hereinafter claimed.

For example, it is reasonably anticipated that search engines may be modified or specifically designed to traverse referent centric social networking, templates, records, structures and transactions related thereto. Another example relates to mobile communications device applications, which may apply heuristics, system specific memory management asymmetry utilization, and bandwidth minimization techniques to allow partial access or improved interactions for referent-centric social networking, and the like. A further example, relates to straightforward graphical interfaces and visualizations that are applied to referent-centric social networking, transactions, interactions, evolution, activity, and the like.

Furthermore, in describing the present invention, explanations are presented in light of currently accepted Information-Economy theories and Network Communications models. Such theories and models are subject to quantitative (computational) & qualitative (cultural) changes, both adiabatic and radical. Often these changes occur because representations for fundamental component elements are innovated, because new transformations between these elements are conceived, or because new interpretations arise for these elements or for their transformations. Therefore, it is important to note that the present invention relates to specific technological actualization in embodiments. Accordingly, theory or model dependent explanations herein, related to these embodiments, are presented for the purpose of teaching, the current man of the art or the current team of the art, how these embodiments may be substantially realized in practice. Alternative or equivalent explanations for these embodiments may neither deny nor alter their realization.

Finally, while the invention has been described with respect to specific examples (such as for ASQ) including presently preferred modes of carrying out the invention, those skilled in the art will appreciate that there are numerous variations and permutations of the above described systems and techniques that fall within the spirit and scope of the invention as set forth in the appended claims. Thus, broadly stated, those skilled in the art will appreciate that systems and methods for amorphous abductive data networking of the instant invention likewise relates to (I) embodiments of electronic communications for a referent-centric community and to facile interactive appurtenances for the respective amorphous communications topology manifold, which the reader may now appreciate are characterized by an open plurality of related-referent events wherein a search event for a referent fragment yields an opportunity event for an abductive comment to the content substantially proximate to the fragment, and therewith provides a conduit for an electronic communications event between a validated author of the comment and an author of referent commented thereto, and the like; and to (II) embodiments of a referent-centric social networking protocol and to facile interactive appurtenances for a virtual amorphous electronic-communications topology manifold; and some typical instant embodiments of the protocol include: a cluster of related actions by an author, a registrar, and a commenter wherein (A) the author publishes a referent to a first electronic communications virtual network, (B) the registrar validates the identity status of a commenter with respect to the author published referent and (C) the registrar validated commenter publishes a comment to the referent via a second electronic communications virtual network that has virtual mutual access with the first electronic communications virtual network. So, simply, at least actualization of these aforementioned instant embodiments, variations, and like aspects help potential customers, struggling knowledge-amateurs, and amateur knowledge-enthusiasts to objectively overcome their current large-data-sample skepticism (and to find a better Umm, as was quaintly described for the reader at the very beginning of the BACKGROUND section).

1. A Referent-Centric Social Network, for improved authenticated services quality validation, the network comprising an ensemble of electronic communications records, wherein said records respectively have: (A) a validated identification of a commenter; (B) a comment owned by the commenter which relates to referent of a different owner, wherein said comment includes at least one third party authenticated profile relationship between the commenter and the referent owner; (C) linkage pointing to a localization of the referent; (D) electronic communications access to the comment; and (E) respective social networking facilities including: (I) an interactive electronic communications access between the commenter and the referent owner, (II) a commenter centric broadcast of the comment to a substantially appropriate group, (III) a referent centric aggregation of related comments from a substantially appropriate group, (IV) a network centric summary of at least one of the aforesaid for a substantially appropriate group, and (V) a dynamic view of the aforesaid.

2. The Network according to claim 1 wherein the localization is selected from the list: a web-presence of the referent, a referent-centric social networking registration for the referent owner, a geographic spatial position for the referent, a time stamp, at least one coordinate to a specific comment-relevant subset of the referent, and a combination of the aforesaid.

3. The Network according to claim 1 wherein the third party is validated in conjunction with an access communication with at least one electronic storage medium selected from the list: public records, private records, proprietary records, a professional license listing, court records, immigration records, criminal records, police records, a news archive, banking records, credit history records, credit rating records, government records, linked profile attribute records, cookies, cookie-like records, elected preference records, Internet accessible information, an authenticated certificate, a photo archive, an audio archive, a multimedia archive, and any combination of the aforesaid.

4. The Network according to claim 1 wherein the authenticated profile relationship relates to at least one attribute of the respective record and the attribute is selected from the list: the commenter, the comment, the referent owner, the referent, the relationship, unique id's acquired by the record for any interrelated process, the access, a profile associated with a mobile device facilitating the access, a profile associated with a user of the mobile device, any word combination within the comment, and any synonym descriptor of the aforesaid.

5. The Network according to claim 1 wherein the electronic communications access includes access to the network via at least one referent-centric aggregation portal, thereby, according to a referent relevant parametric request, facilitating searching of referent, searching of comments to referent, organizing of related data, sorting by tag, sorting by attribute, combinations of the aforesaid, and therewith producing at least one respective summary, report, survey, or linkage to an update one of these, wherein an instantiation of the request is preserved as a record into the ensemble of electronic communications records.

6. The Network according to claim 1 wherein the comment includes at least one expression compliant with a vantage selected from the list: an unsolicited descriptor, a solicited descriptor selected from a predetermined set of descriptor choices, a valuation, a feed-back assessment, a feed-forward suggestion, a grade, a survey, a rating, a vote, a free-form text, an audio segment, a graphic, a video segment, a hyper-link, and a linkage pointing to a localization for a different referent.

7. The Network according to claim 1 wherein the network further includes, for a designated grouping of relationships between at least one commenter and at least one referent owner, a characterization of interactions there-between which are represented by at least one valuation selected from the list: indicia, statistics, metrics, calculus, topology, a filtered subset of any of the aforesaid, a convolution between any of the aforesaid, any information phase-transition dynamics thereof, a graphic summary thereof, an alternate format representation of any of said relationships, and a dashboard thereof.

8. The Network according to claim 7 wherein the network further includes search engine access to characterization of interactions.

9. The Network according to claim 1 wherein the comment includes reference to at least one specific referent-relevant subset and the reference is selected from the list at least one portion of the referent, at least one coordinate within the referent, a coordinate offset within the referent, at least one data structure vector based within the referent, a cross-reference to an alternative juxtaposed referent, and any combination of the aforesaid.

10. The Network according to claim 1 wherein the interactive electronic communications access is selected from the list: Peer to Peer (P2P), Virtual Private Network (VPN), chat room, web portal, mobile application, bulletin board, forum, HTTP, HTTPS, SSL, SSH, Web service, and Remote Procedure Call (RPC).

11. The Network according to claim 10 wherein an instantiation of the electronic communications is preserved as a record into the ensemble of electronic communications records.

12. An Article comprising a non-transitory tangible medium encoding computer-readable instructions that, when applied to one or more computers under the control of an Internet Service Provider (ISP) or of an applications server, instructs one or more of the computers: (I) to enable development of an amorphous electronic-communications topology manifold for a Referent-Centric Social Network, and (II) for an electronic-communications activity therein, to perform abductive logic relevant actions between (ONE) records respectively including therein (A) a validated identification of a commenter, (B) a comment owned by the commenter which relates to referent of different owner, wherein said comment includes at least one third party authenticated profile relationship between the commenter and the referent owner, (C) linkage pointing to a localization of the referent, (D) electronic communications access to the comment, and (E) respective social networking facilities, and (TWO) the respective referent.

13. The article according to claim 12 wherein the respective referent is selected from the list: an advertisement, a news item, a currency exchange rate, a stock price, a bond price, a commodities price, a financial market related announcement, an e-commerce event, an official notification, a news item, a political announcement, a press release, an election notice, a public comment, and a discussion.

14. The article according to claim 12 wherein the instructions include a respective electronic communications protocol portion compliant with an associated authentication server and a mobile device application performing one of the relevant actions.

15. A Referent-Centric Social Networking Method, for a service provider improving authenticated services quality validation for an ensemble of electronic communications records, the method comprising: (I) enabling development of an amorphous electronic-communications topology manifold; (II) for a commenter related electronic-communications activity therein, performing abductive logic relevant actions between (ONE) records respectively including therein (A) a validated identification of a commenter, (B) a comment owned by the commenter which relates to referent of different owner, wherein said comment includes at least one third party authenticated profile relationship between the commenter and the referent owner, (C) linkage pointing to a localization of the referent, (D) electronic communications access to the comment, and (E) respective social networking facilities, and (TWO) the respective referent; and (III) arbitrating basic set theoretic binary relations among the records in the ensemble.

16. The Method according to claim 15 wherein enabling includes (A) from the ensemble of electronic information instantiations having logical referent relationships there between, extracting an electronic address for a commenter of an instantly specified instance therein; and (B) establishing a conduit for electronic communications feedback to the commenter.

17. The Method according to claim 16 wherein establishing the conduit includes verifying a mutually compatible information security protocol there-between.

18. The Method according to claim 15 wherein enabling includes, from the ensemble of electronic information instantiations having logical referent relationships there between, incorporating into the ensemble at least one item related to the respective referent and the item is selected from the list: a text segment, and audio segment, a graphic segment, a video segment, a model, a product, a product manufacturer, a product vendor, a service, a biometric indicia, a service provider, an employer, a geographic location, an event, a news item, identification of a person, identification of a group of persons, identification of an organization, identification of an enterprise, identification of a group of enterprises, an advertisement, a distribution agency, a substantially specified fragment of any of the aforesaid, any combination of the aforesaid, and assigning a probability threshold strategy applicable for a similar referent instantiation.

19. The Method according to claim 15 wherein enabling includes (A) accessing a large plurality of at least two types of related electronic information instantiations wherein the types are selected from the list: (i) content to content, (ii) comment to content, (iii) content to comment, and (iv) comment to comment; by (B) assembling indicia of respective owners of the electronic information; by (C) for the related information, clustering characterization of the owners using the respective indicia; and by (D) therewith facilitating electronic communications between respectively proximate owners.

20. The Method according to claim 15 wherein performing abductive logic relevant actions includes certifying a validity attribute between the referent owner and the respective referent.
